(19) United States
(12) Patent Application Publication
(10) Pub. No.: US 2024/0109994 A1
(43) Pub. Date: Apr. 4, 2024

(54) POLYCYCLIC-OLEFINIC POLYMERS CONTAINING OLEFINIC FUNCTIONALITY FOR FORMING LOW-LOSS FILMS HAVING IMPROVED THERMAL PROPERTIES

(71) Applicant: PROMERUS, LLC, Akron, OH (US)

(72) Inventors: PRAMOD KANDANARACHCHI, AKRON, OH (US); CHERYL BURNS, AKRON, OH (US); DOUG SKILSKYJ, AKRON, OH (US); LARRY F. RHODES, AKRON, OH (US)

(73) Assignee: PROMERUS, LLC, AKRON, OH (US)

(21) Appl. No.: 18/243,304

(22) Filed: Sep. 7, 2023

Related U.S. Application Data
(60) Provisional application No. 63/404,335, filed on Sep. 7, 2022.

(51) Int. Cl. C08F 232/08; C08J 5/18; C08K 5/14; C08K 5/315; C08L 45/00

(52) U.S. Cl. CPC C08F 232/08; C08J 5/18; C08K 5/14; C08K 5/315; C08L 45/00; C08F 2800/10; C08F 2810/20; C08J 2345/00; C08L 2203/16; C08L 2205/06; C08L 2312/00

(57) ABSTRACT

Embodiments in accordance with the present invention encompass copolymers and terpolymers of a variety of polycycloolefinic monomers at least one of which monomer contains an additional unpolymerized ethylenic bond. In further aspect of this invention there is provided an embodiment encompassing compositions containing the polymers of this invention, a crosslinker, a free radical initiator, a tackifier and one or more suitable additives. The compositions of this invention can be formed into a variety of three-dimensional insulating articles upon exposure to suitable high temperature, such as for example films. The objects formed from the compositions of this invention exhibit hitherto unattainable low dielectric constant and low-loss properties, and very high thermal properties. The compositions of this invention may additionally contain one or more organic or inorganic filler materials, which provide improved thermo-mechanical properties in addition to very low dielectric properties. The compositions of this invention are useful in various applications, including as insulating materials in millimeter wave radar antennas, among others.

### CROSS REFERENCE TO RELATED APPLICATIONS

This application claims the benefit of U.S. Provisional Application No. 63/404,335, filed Sep. 7, 2022, which is incorporated herein by reference in its entirety.

### BACKGROUND OF THE INVENTION

### Field of the Invention

Embodiments in accordance with the present invention relate generally to polymers formed from two or more polycycloolefinic monomers at least one of which monomers containing a free olefinic functionality. More specifically, this invention relates to a polymer containing two or more substituted norbornene derivatives among which at least one monomer contains at least one free olefinic functionality. The embodiments of this invention further relate to compositions containing such polymers in combination with a tackifier, a crosslinker, a free radical initiator and one or more additives. The compositions of this invention can readily be formed into films, which are useful as low loss thermosets and prepregs for copper clad laminates which not only exhibit low dielectric constant and low-loss properties but also very high thermal properties. For example, films formed from the compositions of this invention generally exhibit high glass transition temperature, which range from about 150° C. to 280° C., and also exhibit low dielectric constant (from about 2.2 to 3.0 at a frequency of 10 GHz), low dielectric dissipation factor (from about 0.001 to 0.002 at a frequency of 10 GHz), and coefficient of thermal expansion (CTE) as low as 50 ppm/K. Accordingly, the polymers and composition of this invention find applications as insulating materials in a variety of applications including electromechanical devices having applications in the fabrication of a number of automotive parts, among others.

### Description of the Art

It is well known in the art that insulating materials having low dielectric constant (Dk) and low-loss, also referred to as dielectric dissipation factor, (Df) are important in printed circuit boards catering to electrical appliances and automotive parts and other applications. Generally, in most of such devices the insulating materials that are suitable must have dielectric constant lower than 3 and low-loss lower than 0.002 at high frequencies such as for example greater than 10 GHz. Also, there is an increased interest in developing organic dielectric materials as they are easy to fabricate among other advantages.

However, the use of such materials in printed circuit boards as copper-clad laminates need high performance thermosets having high glass transition temperatures (T_{g}), low CTEs, low Dk/Df, high peel strength on copper and good reliability at high temperature storage. The ability to form prepreg (composite with glass cloth), B-staging capability (generate a layer of material that is not cross linked or partially cross linked) and film fusing capability for fabricating layered structures are also important. Most commercial materials available in the art have not attained all of these properties, especially low Dk/Df and high glass transition temperatures, higher than 150° C.

In addition, there are significant technical challenges in developing such insulating materials meeting all of the requirements. One such challenge is that such materials exhibit low coefficient of thermal expansion (CTE), which is preferably less than 50 ppm/K due to concerns of peeling from copper layers. Another challenge is that such materials exhibit very high glass transition temperature (T_{g}), which is preferably greater than 150° C. or even higher than 250° C. due to the process conditions used in the manufacture of printed circuit boards as well as harsh conditions the devices may encounter, such as for example millimeter-wave Radar antennas used in the automobiles and other terminal equipment in 5G devices.

Although films made from the addition polymerization of norbornene derivatives containing long side chains, such as for example, 5-hexylnorbornene (HexNB) and 5-decylnorbornene (DecNB) are known to have low Dk and Df due to their hydrophobic nature these films exhibit high CTE (>200 ppm/K) and low T_{g}. See, for example, JP 2016037577A and JP 2012121956A.

It has also been reported in the literature that certain of the polymers, such as for example, fluorinated poly-ethylene, poly-ethylene and poly-styrene feature low Dk/Df but all of such polymers are unsuitable as organic insulating materials as they exhibit very low glass transition temperatures, which can be much lower than 150° C. Further, it has also been reported in the literature that generally low CTE and high T_{g} polymers can be generated when certain substituted norbornenes substituted with polar groups such an ester or alcohol groups are incorporated. However, incorporation of such groups will increase both Dk and Df due to their polarizability under an electromagnetic field, particularly at high frequencies. Therefore, such polar group substituted norbornenes are unsuitable in forming insulating materials as contemplated herein.

U.S. Pat. No. 10,897,818 B2 discloses a composition containing modified polyphenylene ether containing vinyl benzyl end groups, a cross linker such as 1,3,5-triallyl-1,3,5-triazinane-2,4,6-trione, also known as triallyl isocyanurate (TAIC) and an epoxy compound. However, the compositions reported therein exhibit high Dk of about 3.7 and Df of about 0.005 albeit reasonably high T_{g} ranging from about 200-230° C.

Therefore, there is still a need to develop new insulating materials that exhibit not only low dielectric properties but also very high thermal properties.

In addition, there is also a need to develop materials, which can form thermoset films rather than thermoplastic films. That is, the thermosets are generally cross-linked structures, which are more stable to higher temperatures and do not exhibit any thermal mobility unlike thermoplastics.

Accordingly, it is an object of this invention to provide a polymer containing two or more monomers of substituted norbornenes, one of which monomer contains at least one olefinic functionality, and a composition derived therefrom which can be formed into an insulating material having hitherto unattainable properties.

Other objects and further scope of the applicability of the present invention will become apparent from the detailed description that follows.

### SUMMARY OF THE INVENTION

Surprisingly, it has now been found that employing a polymer containing two or more polycyclic olefinic monomers of formulae (I) and (II) as described herein which contain at least four or more mole percent of a monomer of formula (II), it is now possible to form a polymer, which can be used in compositions as described herein to form a variety of three-dimensional objects, including films, which provide hitherto unattainable dielectric as well as thermal properties.

In another aspect of this invention there is also provided a film, a composite, a prepreg comprising the composition of this invention.

### BRIEF DESCRIPTION OF THE DRAWINGS

Embodiments in accordance with the present invention are described below with reference to the following accompanying figures and/or images. Where drawings are provided, it will be drawings which are simplified portions of various embodiments of this invention and are provided for illustrative purposes only.

FIG. 1 shows graphical plots of dielectric reliability studies at a storage temperature of 125° C. over a period of 1000 hours of a few of the exemplary films formed from the compositions of this invention, which are compared with comparative compositions available in the art as described herein.

FIG. 2 shows graphical plots of dielectric reliability studies at a storage temperature of 125° C. over a period of 1000 hours of a few of the exemplary films formed from yet a few other composition embodiments of this invention.

FIG. 3 shows graphical plots of dielectric stability at 85° C. and 85 percent relative humidity (RH) over a period of 1400 hours of a few of the exemplary films formed from the composition embodiments of this invention.

FIG. 4 shows a graphical plot illustrating the effects of resin flow using a composition embodiment of this invention containing varied amounts of high molecular weight polymer in combination with a low molecular weight polymer for forming copper-clad laminates in accordance with this invention.

### DETAILED DESCRIPTION OF THE INVENTION

The terms as used herein have the following meanings:

As used herein, the articles “a,” “an,” and “the” include plural referents unless otherwise expressly and unequivocally limited to one referent.

Since all numbers, values and/or expressions referring to quantities of ingredients, reaction conditions, etc., used herein and in the claims appended hereto, are subject to the various uncertainties of measurement encountered in obtaining such values, unless otherwise indicated, all are to be understood as modified in all instances by the term “about.”

Where a numerical range is disclosed herein such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein. For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10, etc.

As used herein, “hydrocarbyl” refers to a group that contains carbon and hydrogen atoms, non-limiting examples being alkyl, cycloalkyl, aryl, aralkyl, alkaryl, and alkenyl. The term “halohydrocarbyl” refers to a hydrocarbyl group where at least one hydrogen has been replaced by a halogen. The term perhalocarbyl refers to a hydrocarbyl group where all hydrogens have been replaced by a halogen.

As used herein, the expression “alkyl” means a saturated, straight-chain or branched-chain hydrocarbon substituent having the specified number of carbon atoms. Particular alkyl groups are methyl, ethyl, n-propyl, isopropyl, tert-butyl, and so on. Derived expressions such as “alkoxy,” “thioalkyl,” “alkoxyalkyl,” “hydroxyalkyl,” “alkylcarbonyl,” “alkoxycarbonylalkyl,” “alkoxycarbonyl,” “diphenylalkyl,” “phenylalkyl,” “phenylcarboxyalkyl” and “phenoxyalkyl” are to be construed accordingly.

As used herein, the expression “cycloalkyl” includes all of the known cyclic groups. Representative examples of “cycloalkyl” includes without any limitation cyclopropyl, cyclobutyl, cyclopentyl, cyclohexyl, cycloheptyl, cyclooctyl, and the like. Derived expressions such as “cycloalkoxy,” “cycloalkylalkyl,” “cycloalkylaryl,” “cycloalkylcarbonyl” are to be construed accordingly.

As used herein, the expression “perhaloalkyl” represents the alkyl, as defined above, wherein all of the hydrogen atoms in said alkyl group are replaced with halogen atoms selected from fluorine, chlorine, bromine, or iodine. Illustrative examples include trifluoromethyl, trichloromethyl, tribromomethyl, triiodomethyl, pentafluoroethyl, pentachloroethyl, pentabromoethyl, pentaiodoethyl, and straight-chained or branched heptafluoropropyl, heptachloropropyl, heptabromopropyl, nonafluorobutyl, nonachlorobutyl, undecafluoropentyl, undecachloropentyl, tridecafluorohexyl, tridecachlorohexyl, and the like. Derived expression, “perhaloalkoxy,” is to be construed accordingly. It should further be noted that certain of the alkyl groups as described herein may partially be fluorinated, that is, only portions of the hydrogen atoms in said alkyl group are replaced with fluorine atoms and shall be construed accordingly.

As used herein the expression “acyl” shall have the same meaning as “alkanoyl,” which can also be represented structurally as “R—CO—,” where R is an “alkyl” as defined herein having the specified number of carbon atoms. Additionally, “alkylcarbonyl” shall mean same as “acyl” as defined herein. Specifically, “(C₁-C₄)acyl” shall mean formyl, acetyl or ethanoyl, propanoyl, n-butanoyl, etc. Derived expressions such as “acyloxy” and “acyloxyalkyl” are to be construed accordingly.

As used herein, the expression “aryl” means substituted or unsubstituted phenyl or naphthyl. Specific examples of substituted phenyl or naphthyl include o-, p-, m-tolyl, 1,2-, 1,3-, 1,4-xylyl, 1-methylnaphthyl, 2-methylnaphthyl, etc. “Substituted phenyl” or “substituted naphthyl” also include any of the possible substituents as further defined herein or one known in the art.

As used herein, the expression “arylalkyl” means that the aryl as defined herein is further attached to alkyl as defined herein. Representative examples include benzyl, phenylethyl, 2-phenylpropyl, 1-naphthylmethyl, 2-naphthylmethyl and the like.

As used herein, the expression “alkenyl” means a non-cyclic, straight, or branched hydrocarbon chain having the specified number of carbon atoms and containing at least one carbon-carbon double bond, and includes ethenyl and straight-chained or branched propenyl, butenyl, pentenyl, hexenyl, and the like. Derived expression, “arylalkenyl” and five membered or six membered “heteroarylalkenyl” is to be construed accordingly. Illustrative examples of such derived expressions include furan-2-ethenyl, phenylethenyl, 4-methoxyphenylethenyl, and the like.

As used herein, the expression “heteroaryl” includes all of the known heteroatom containing aromatic radicals. Representative 5-membered heteroaryl radicals include furanyl, thienyl or thiophenyl, pyrrolyl, isopyrrolyl, pyrazolyl, imidazolyl, oxazolyl, thiazolyl, isothiazolyl, and the like. Representative 6-membered heteroaryl radicals include pyridinyl, pyridazinyl, pyrimidinyl, pyrazinyl, triazinyl, and the like radicals. Representative examples of bicyclic heteroaryl radicals include, benzofuranyl, benzothiophenyl, indolyl, quinolinyl, isoquinolinyl, cinnolyl, benzimidazolyl, indazolyl, pyridofuranyl, pyridothienyl, and the like radicals.

As used herein, the expression “heterocycle” includes all of the known reduced heteroatom containing cyclic radicals. Representative 5-membered heterocycle radicals include tetrahydrofuranyl, tetrahydrothiophenyl, pyrrolidinyl, 2-thiazolinyl, tetrahydrothiazolyl, tetrahydrooxazolyl, and the like. Representative 6-membered heterocycle radicals include piperidinyl, piperazinyl, morpholinyl, thiomorpholinyl, and the like. Various other heterocycle radicals include, without limitation, aziridinyl, azepanyl, diazepanyl, diazabicyclo[2.2.1]hept-2-yl, and triazocanyl, and the like.

“Halogen” or “halo” means chloro, fluoro, bromo, and iodo.

In a broad sense, the term “substituted” is contemplated to include all permissible substituents of organic compounds. In a few of the specific embodiments as disclosed herein, the term “substituted” means substituted with one or more substituents independently selected from the group consisting of (C₁-C₆)alkyl, (C₂-C₆)alkenyl, (C₁-C₆)perfluoroalkyl, phenyl, hydroxy, —CO₂H, an ester, an amide, (C₁-C₆)alkoxy, (C₁-C₆)thioalkyl and (C₁-C₆)perfluoroalkoxy. However, any of the other suitable substituents known to one skilled in the art can also be used in these embodiments.

It should be noted that any atom with unsatisfied valences in the text, schemes, examples, and tables herein is assumed to have the appropriate number of hydrogen atom(s) to satisfy such valences.

It will be understood that the terms “dielectric” and “insulating” are used interchangeably herein. Thus, reference to an insulating material or layer is inclusive of a dielectric material or layer and vice versa. Further, as used herein, the term “organic electronic device” will be understood to be inclusive of the term “organic semiconductor device” and the several specific implementations of such devices used, for example, in automotive industry.

As used herein, the dielectric constant (Dk) of a material is the ratio of the charge stored in an insulating material placed between two metallic plates to the charge that can be stored when the insulating material is replaced by vacuum or air. It is also called as electric permittivity or simply permittivity. And, at times referred as relative permittivity, because it is measured relatively from the permittivity of free space.

As used herein, “low-loss” is the dissipation factor (Df), which is a measure of loss-rate of energy of a mode of oscillation (mechanical, electrical, or electromechanical) in a dissipative system. It is the reciprocal of quality factor, which represents the “quality” or durability of oscillation.

As used herein, “B-stage” means a material wherein the reaction between the base polymer and the curing agent/hardener is not complete. That is, such “B-staged” material is in a partially cured stage, and generally free of any solvent used to make the composition containing the base polymer and the curing agent/hardener. Generally, when such “B-staged” material is reheated at elevated temperature, the cross-linking is complete, and the material is fully cured.

As used herein, “prepreg” means a material that is pre-impregnated with a polymeric material which can be either a thermoplastic or a thermoset. Generally, a fibrous material such as glass cloth is pre-impregnated with a polymeric material to form prepregs, which is formed by a “B-stage” process and subsequently cured by reheating at elevated temperature.

By the term “derived” is meant that the polymeric repeating units are polymerized (formed) from, for example, polycyclic norbornene-type monomers in accordance with formulae (I) or (II) wherein the resulting polymers are formed by 2,3 enchainment of norbornene-type monomers as shown below:

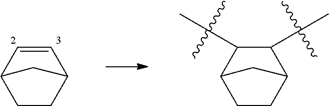

The above polymerization is also known widely as vinyl addition polymerization typically carried out in the presence of organometallic compounds such as organopalladium compounds or organonickel compounds as further described in detail below.

Thus, in accordance with the practice of this invention there is provided a polymer comprising:
a) at least one first repeating unit represented by formula (IA), said first repeating unit is derived from a monomer of formula (I):

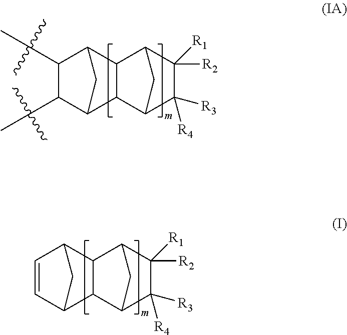

wherein:
[symbol] denotes a place of bonding with another repeat unit;
m is an integer 0, 1 or 2;
R₁, R₂, R₃ and R₄ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
b) at least one second repeating unit represented by formula (IIA), said second repeating unit is derived from a monomer of formula (II):

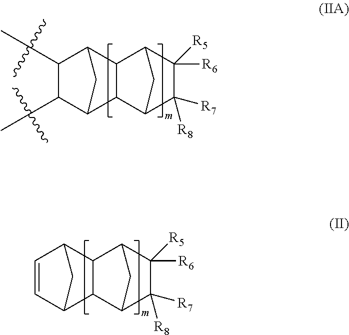

wherein:
[symbol] denotes a place of bonding with another repeat unit;
n is an integer 0, 1 or 2;
at least one of R₅, R₆, R₇ and R₈ is selected from the group consisting of methylidene, ethylidene, vinyl, linear or branched (C₃-C₁₆)alkenyl, (C₃-C₁₀)cycloalkenyl, (C₆-C₁₂)bicycloalkenyl and (C₆-C₁₂)aryl(C₂-C₁₆)alkenyl and the remaining R₅, R₆, R₇ and R₈ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring containing at least one double bond;
and
wherein the second repeat unit is present at an amount not less than four mole percent based on total moles of first and second repeat units.

The polymer as described herein can be prepared by any of the known vinyl addition polymerization in the art. It has now been found that the copolymerization of one or more monomers of formula (I) with one or more monomers of formula (II) it is now possible to form polymers in accordance with this invention where the additional olefinic functionality present in monomer of formula (II) remains unreactive during vinyl addition polymerization and such olefinic functionality remains available in the polymer for other uses. Thus, the polymers of this invention can be used in a variety of applications where further crosslinking with other materials can be carried out. Such methods include formation of prepregs suitable in the fabrication of printed circuit boards, such as copper clad laminates. It has now been found that even incorporation of small amounts of monomer of formula (II) it is now possible to form polymers in accordance with this invention which are quite effective in forming crosslinkable compositions of this invention as described in detail below.

Advantageously, it has now been found that the additional olefinic functionality present in the monomers of formula (II) is not reactive to the vinyl addition polymerization catalyst, and therefore remains present after formation of the polymer in accordance with this invention. That is, one of olefinic groups present in R₅, R₆, R₇ and R₈ of the monomer of formula (II) remains available in the polymer formed in accordance with this invention. Therefore, the polymers of this invention are useful in a variety of applications where there is a need for further reaction involving the olefinic functionality, such as for example, crosslinking with other materials. It has been further observed that the amount of monomer of formula (II) employed can be as little as four (4) mole percent of the total amount of combined monomers of formulae (I) and (II) in order to observe the crosslinking ability of the polymers of this invention.

Accordingly, in some embodiments the amount of repeat units of monomer of formula (IIA) present in the polymer is at least four mole percent based on the total moles of first and second repeat units of formulae (IA) and (IIA). In some other embodiments the amount of repeat units of monomer of formula (IIA) present in the polymer is from about five mole percent to about forty mole percent, from about ten mole percent to about thirty mole percent, from about fifteen mole percent to about twenty-five mole percent, and so on, based on the total moles of first and second repeat units of formulae (IA) and (IIA). In yet some other embodiments the amount of repeat units of monomer of formula (IIA) present in the polymer is from about six mole percent to thirty mole percent based on the total moles of first and second repeat units of formulae (IA) and (IIA).

As noted, more than one monomer of formula (I) with at least one monomer of formula (II) can be used to form the polymer of this invention. Advantageously, it has now been found that at least two distinctive monomers of formula (I) are employed with one monomer of formula (II). Again, any desirable amounts of distinctive monomers of formula (I) can be used in combination with a monomer of formula (II) as described herein. In some embodiments such molar ratios of distinctive monomers of formula (I) can be 10:90, 20:80, 30:70, 40:60, 50:50, and so on.

In some embodiments, the polymer according to this invention is having a repeat units of formula (IA) wherein m is 0 or 1. In some other embodiments, the polymer according to this invention is having a repeat units of formula (IA) wherein m is zero. That is, the repeat units of formula (IA) are derived from a monomer of formula (I), which is a derivative of norbornene. Again, one or more distinct monomers of formula (I) can be used to form the polymer of this invention. In some other embodiments the monomer of formula (I) employed is having m equals 1. That is, the monomer employed in this embodiment contains a dimeric norbornene monomer unit, which is also known as tetracyclodecene (TD). However, it should be noted that a combination of monomers of formula (I) having m=0 and m=1 can also be used to form the polymer of this invention. That is, a mixture of norbornene derivatives of formula (I) as described herein can be employed with a suitable tetracyclodecene derivative of formula (I) as described herein can be used to form the polymer of this invention. Again, any suitable amounts of these distinct monomers of formula (I) which will bring about the intended benefit can be employed to form the polymers of this invention. Accordingly, in some embodiments, the polymer according to this invention, encompasses the first repeat unit derived from two distinct monomers of formula (I).

Similarly, in some other embodiments, the polymer according to this invention is having a repeat units of formula (IIA) wherein n is 0 or 1. In some other embodiments, the polymer according to this invention is having a repeat units of formula (IIA) wherein n is zero. That is, the repeat units of formula (IIA) are derived from a monomer of formula (II), which is a derivative of norbornene. Again, one or more distinct monomers of formula (II) can be used to form the polymer of this invention. In some other embodiments the monomer of formula (II) employed is having n equals 1. That is, the monomer employed in this embodiment contains a dimeric norbornene monomer unit, which is also known as tetracyclodecene (TD). However, it should be noted that a combination of monomers of formula (II) having n=0 and n=1 can also be used to form the polymer of this invention. That is, a mixture of norbornene derivatives of formula (II) as described herein can be employed with a suitable tetracyclodecene derivative of formula (II) can be used to form the polymer of this invention. Again, any suitable amounts of these distinct monomers which will bring about the intended benefit can be employed to form the polymers of this invention.

In some embodiments, R₁, R₂, R₃ and R₄ are the same or different and each independently selected from the group consisting of hydrogen, methyl, ethyl, n-propyl, n-butyl, n-hexyl, cyclopentyl, cyclohexyl and norbornyl.

In some other embodiments, one of R₁ and R₂ taken together with one of R₃ and R₄ and the carbon atoms to which they are attached to form a cyclopentyl, cyclohexyl, cycloheptyl, bicycloheptyl, bicyclooctyl, or adamantyl ring.

In yet some other embodiments, at least one of R₅, R₆, R₇ and R₈ is selected from the group consisting of ethylidene, vinyl, propenyl, butenyl, pentenyl, hexenyl, heptenyl, octenyl, cyclopentenyl and cyclohexenyl, and the remaining R₅, R₆, R₇ and R₈ are the same or different and each independently selected from the group consisting of hydrogen, methyl, ethyl, n-propyl, n-butyl, n-hexyl, cyclopentyl, cyclohexyl and norbornyl.

In some embodiments, one of R₅ and R₆ taken together with one of R₇ and R₈ and the carbon atoms to which they are attached to form a cyclopentenyl, cyclohexenyl, cycloheptenyl, bicycloheptenyl or bicyclooctenyl ring.

Again, any of the monomers of formula (I) within the scope of this invention can be employed to form the polymers of this invention. Non-limiting examples of such monomers of formula (I) may be selected from the group consisting of:

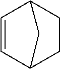

bicyclo[2.2.1]hept-2-ene (norbornene or NB);

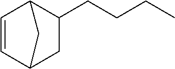

5-butylbicyclo[2.2.1]hept-2-ene (BuNB);

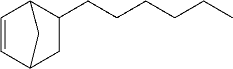

5-hexylbicyclo [2.2.1]hept-2-ene (HexNB);

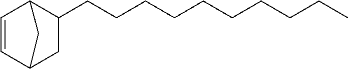 [SMILES: CCCCCCCCCCC1CC2C=CC1C2]

5-decylbicyclo[2.2.1]hept-2-ene (DecNB);

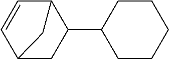 [SMILES: C1=CC2CC1CC2C1CCCCC1]

5-cyclohexylbicyclo[2.2.1]hept-2-ene (CyHexNB);

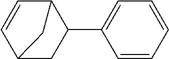 [SMILES: C1=CC2CC1CC2c1ccccc1]

5-phenylbicyclo[2.2.1]hept-2-ene (PhNB);

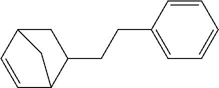 [SMILES: C1=CC2CC1CC2CCc1ccccc1]

5-phenethylbicyclo[2.2.1]hept-2-ene (PENB);

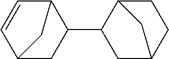 [SMILES: C1=CC2CC1CC2C1CC2CCC1C2]

2,2′-bi(bicyclo[2.2.1]heptan-5-ene) (NBANB);

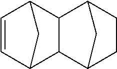 [SMILES: C1=CC2CC1C1C3CCC(C3)C21]

1,2,3,4,4a,5,8,8a-octahydro-1,4:5,8-dimethanonaphthalene (TD); and

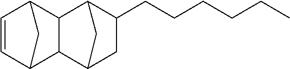 [SMILES: CCCCCCC1CC2CC1C1C3C=CC(C3)C21]

2-hexyl-1,2,3,4,4a,5,8,8a-octahydro-1,4:5,8-dimethanonaphthalene (HexTD).

Similarly, any of the monomers of formula (II) within the scope of this invention can be employed to form the polymers of this invention. Non-limiting examples of such monomers of formula (II) may be selected from the group consisting of:

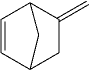

5-methylidenebicyclo[2.2.1]hept-2-ene (MNB);

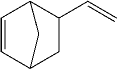

5-vinylbicyclo[2.2.1]hept-2-ene (VNB);

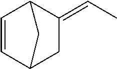

5-ethylidenebicyclo[2.2.1]hept-2-ene (ENB);

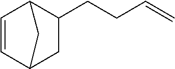

5-(but-3-en-1-yl)bicyclo[2.2.1]hept-2-ene (ButenylNB);

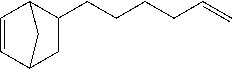

5-(hex-5-en-1-yl)bicyclo[2.2.1]hept-2-ene (HexenylNB);

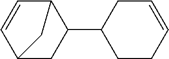 [SMILES: C1=CCC(C2CC3C=CC2C3)CC1]

5-(cyclohex-3-en-1-yl)bicyclo[2.2.1]hept-2-ene (CyclohexeneNB);

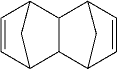 [SMILES: C1=CC2CC1C1C3C=CC(C3)C21]

1,4,4a,5,8,8a-hexahydro-1,4:5,8-dimethanonaphthalene (TDD);

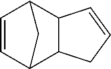

3a,4,7,7a-tetrahydro-1H-4,7-methanoindene (DCPD); and

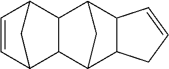 [SMILES: C1=CC2C(C1)C1CC2C2C3C=CC(C3)C12]

3a,4,4a,5,8,8a,9,9a-octahydro-1H-4,9:5,8-dimethanocyclopenta[b]naphthalene (CPD3).

Exemplary non-limiting examples of polymer according to this invention may be enumerated as follows:
a copolymer of norbornene (NB) and 5-vinylbicyclo[2.2.1]hept-2-ene (VNB);
a copolymer of norbornene (NB) and 5-ethylidenebicyclo[2.2.1]hept-2-ene (ENB);
a copolymer of norbornene (NB) and 5-(but-3-en-1-yl)bicyclo[2.2.1]hept-2-ene (ButenylNB);
a copolymer of norbornene (NB) and 5-hex-5-en-1-yl)bicyclo [2.2.1]hept-2-ene (HexenylNB); and
a copolymer of norbornene (NB) and 5-cyclohex-3-en-1-yl)bicyclo[2.2.1]hept-2-ene (CyclohexeneNB);
a terpolymer of norbornene (NB), 5-butylbicyclo[2.2.1]hept-2-ene (BuNB) and 5-(but-3-en-1-yl)bicyclo[2.2.1]hept-2-ene (ButenylNB);
a terpolymer of norbornene (NB), 5-butylbicyclo[2.2.1]hept-2-ene (BuNB) and 5-(cyclohex-3-en-1-yl)bicyclo[2.2.1]hept-2-ene (CyclohexeneNB);
a terpolymer of norbornene (NB), 5-hexylbicyclo[2.2.1]hept-2-ene (HexNB) and 5-(but-3-en-1-yl)bicyclo[2.2.1]hept-2-ene (ButenylNB);
a terpolymer of norbornene (NB), 5-hexylbicyclo[2.2.1]hept-2-ene (HexNB) and 5-(hex-5-en-1-yl)bicyclo[2.2.1]hept-2-ene (HexenylNB); and
a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB).

Surprisingly, it has now been observed that employing even amounts of about four mole percent of a monomer of formula (II) based on the total moles of monomers of formulae (I) and (II) it is now possible to form a polymer according to this invention which brings about effective crosslinking ability with other materials in forming a composite material having utility in a variety of applications as described hereinbelow. In some embodiments, the polymer according to this invention encompasses the second repeat unit of formula (II), which is present at an amount in the range from about five mole percent to about thirty mole percent based on the total moles of first repeat unit(s) of formula (I) and second repeat unit(s) of formula (II). In some other embodiments, the polymer according to this invention encompasses the second repeat unit of formula (II), which is present at an amount in the range from about ten mole percent to about twenty-five mole percent based on the total moles of first repeat unit(s) of formula (I) and second repeat unit(s) of formula (II). In yet some other embodiments, the polymer according to this invention encompasses the second repeat unit of formula (II), which is present at an amount in the range from about fifteen mole percent to about twenty mole percent based on the total moles of first repeat unit(s) of formula (I) and second repeat unit(s) of formula (II). However, it should be noted that in some embodiments the amount of repeat unit of formula (II) may be less than four mole percent or also can be higher than thirty mole percent depending upon the intended application. Accordingly, all such possible combinations of amounts that can be employed are well within the scope of this invention.

As noted, the monomers of formulae (I) and (II) undergo vinyl addition polymerization using any of the suitable catalysts known in the art. For example, various palladium compounds, platinum compounds as well as various nickel compounds have been used to form polymers of the types described herein. In some embodiments of this invention the polymer of this invention is formed by employing a palladium compound. Various palladium compounds known in the art can be employed. Non-limiting examples of such palladium compounds, including a few platinum compounds may be enumerated as follows:
palladium (II) bis(triphenylphosphine) dichloride;
palladium (II) bis(triphenylphosphine) dibromide;
palladium (II) bis(triphenylphosphine) diacetate;
palladium (II) bis(triphenylphosphine) bis(trifluoroacetate);
palladium (II) bis(tricyclohexylphosphine) dichloride;
palladium (II) bis(tricyclohexylphosphine) dibromide;
palladium (II) bis(tricyclohexylphosphine) diacetate (Pd785);
palladium (II) bis(tricyclohexylphosphine) bis(trifluoroacetate);
palladium (II) bis(tri-p-tolylphosphine) dichloride;
palladium (II) bis(tri-p-tolylphosphine) dibromide;
palladium (II) bis(tri-p-tolylphosphine) diacetate;
palladium (II) bis(tri-p-tolylphosphine) bis(trifluoroacetate);
palladium (II) ethyl hexanoate;
bis(acetonato)palladium (II);
dichloro bis(benzonitrile)palladium (II);
n-butyldi-1-adamantylphosphine palladium diacetate(H₂O) (Pd601);
n-butyldi-tert-butylphosphine palladium diacetate(H₂O) (Pd445);
bis(n-butyl-di-1-adamantylphosphine) palladium acetate(acetonitrile) tetrakis(pentafluorophenyl)borate (Pd1602); and
(acetonitrile)bis(triisopropylphosphine)palladium(acetate)tetrakis(pentafluorophenyl) borate (Pd1206);
[(allyl)palladium(trinaphthylphosphine)(trifluoroacetate)];
[(allyl)palladium(trinaphthylphosphine)(trifluoromethanesulfonate)];
platinum (II) chloride;
platinum (II) bromide; and
platinum bis(triphenylphosphine)dichloride.

It is also well known in the art that such palladium compounds are further activated using a variety of activator compounds. Non-limiting examples of such activators may be selected from the group consisting of:
lithium tetrafluoroborate;
lithium triflate;
lithium tetrakis(pentafluorophenyl)borate;
lithium tetrakis(pentafluorophenyl)borate etherate (LiFABA);
sodium tetrakis(pentafluorophenyl)borate etherate (NaFABA);
trityl tetrakis(pentafluorophenyl)borate etherate (tritylFABA);
tropylium tetrakis(pentafluorophenyl)borate etherate (tropyliumFABA);
lithium tetrakis(pentafluorophenyl)borate isopropanolate;
lithium tetraphenylborate;
lithium tetrakis(3,5-bis(trifluoromethyl)phenyl)borate;
lithium tetrakis(2-fluorophenyl)borate;
lithium tetrakis(3-fluorophenyl)borate;
lithium tetrakis(4-fluorophenyl)borate;
lithium tetrakis(3,5-difluorophenyl)borate;
lithium hexafluorophosphate;
lithium hexaphenylphosphate;
lithium hexakis(pentafluorophenyl)phosphate;
lithium hexafluoroarsenate;
lithium hexaphenylarsenate;
lithium hexakis(pentafluorophenyl)arsenate;
lithium hexakis(3,5-bis(trifluoromethyl)phenyl)arsenate;
lithium hexafluoroantimonate;
lithium hexaphenylantimonate;
lithium hexakis(pentafluorophenyl)antimonate;
lithium hexakis(3,5-bis(trifluoromethyl)phenyl)antimonate;
lithium tetrakis(pentafluorophenyl)aluminate;
lithium tris(nonafluorobiphenyl)fluoroaluminate;
lithium (octyloxy)tris(pentafluorophenyl)aluminate;
lithium tetrakis(3,5-bis(trifluoromethyl)phenyl)aluminate;
lithium methyltris(pentafluorophenyl)aluminate; and
dimethylanilinium tetrakis(pentafluorophenyl)borate (DANFABA).

Generally, the polymerization is carried out in a suitable solvent and at a suitable temperature. Any of the solvents that can solubilize the palladium compounds and the monomers employed or miscible with the liquid monomers can be employed for this purpose. Suitable polymerization solvents include without any limitation, alkane and cycloalkane solvents, such as pentane, hexane, heptane, decalin, cyclohexane and methyl cyclohexane; halogenated alkane solvents such as dichloromethane, chloroform, carbon tetrachloride, ethylchloride, 1,1-dichloroethane, 1,2-dichloroethane, 1-chloropropane, 2-chloropropane, 1-chlorobutane, 2-chlorobutane, 1-chloro-2-methylpropane, and 1-chloropentane; ethers such as THF and diethylether; aromatic solvents such as benzene, xylene, toluene, mesitylene, chlorobenzene, and o-dichlorobenzene; and halocarbon solvents such as Freon® 112; ester solvents such as methyl acetate, ethyl acetate, butyl acetate and amyl acetate; and mixtures in any combination thereof.

Any of the temperature conditions that will bring about such polymerization can be used herein. In some embodiments, the polymer of this invention is formed by heating a mixture containing suitable amounts of monomers of formulae (I) and (II) in the presence of a palladium compound and the activator as described herein at a temperature in the range of about 60° C. to about 150° C. for a sufficient length of time, for example from about one hour to eight hours. In some other embodiments, the monomer mixture with the catalyst is heated to a temperature of about 90° C. to about 130° C. for a sufficient length of time, for example from about one hour to four hours to form the polymer of this invention. Further, the solution polymerization is carried out under an inert atmosphere, such as for example, under nitrogen, helium or argon atmosphere and using anhydrous solvents.

Advantageously, the vinyl addition polymer is formed from a palladium compound and monomers of formulae (I) and (II) with very high conversion at low (for example 20,000-25,000 to 1) catalyst loading, where the polymer's molecular weight is controlled using a chain transfer agent, such as, triethylsilane (TES). Various other chain transfer agents can also be used to control the molecular weight of the resulting polymer as described herein, including for example, bicyclo[4.2.0]oct-7-ene (BCO), formic acid, various other silanes, and the like, including mixtures in any combination thereof. Use of various CTAs in vinyl addition polymerization in order to control the resulting polymer properties is well known in the art. See, for example, U.S. Pat. No. 9,771,443 B2, pertinent portions of which are incorporated herein by reference.

The polymers formed according to this invention generally exhibit a weight average molecular weight (M_{w}) of at least about 1,000. In another embodiment, the polymer of this invention has a M_{w} of at least about 3,000, 5,000, 10,000 or 20,000. In another embodiment, the polymer of this invention has a M_{w} of at least about 50,000. In another embodiment, the polymer of this invention has a M_{w} of at least about 60,000. In another embodiment, the polymer of this invention has a M_{w} of at least about 70,000. In yet another embodiment, the polymer of this invention has a M_{w} of at least about 80,000. In some other embodiments, the polymer of this invention has a M_{w} of at least about 100,000. In another embodiment, the polymer of this invention has a M_{w} of higher than 150,000, higher than 200,000 and can be higher than 500,000 in some other embodiments. The weight average molecular weight (M_{w}) of the polymer can be determined by any of the known techniques, such as for example, by gel permeation chromatography (GPC) equipped with suitable detector and calibration standards, such as differential refractive index detector calibrated with narrow-distribution polystyrene standards or polybutadiene (PBD) standards. The polymers of this invention typically exhibit polydispersity index (PDI) higher than 3, which is a ratio of weight average molecular weight (M_{w}) to number average molecular weight (Mₙ). In general, the PDI of the polymers of this invention ranges from 3 to 5. In some embodiments the PDI is higher than 3.5, higher than 4, higher than 4.5, or can be higher than 5. However, it should be noted that in some embodiments the PDI can be lower than 3, such as for example, 2.5.

The polymer thus formed is then used to make the compositions as described herein, which is used to produce composite materials having hitherto unattainable properties, such as for example, extremely low coefficient of thermal expansion (CTE), which can be as low as 100 ppm/° K, below 90 ppm/° K, 80 ppm/° K, 50 ppm/° K or lower than 40 ppm/° K. The polymer of this invention also exhibits extremely low dielectric constant as well as low loss properties. For example, dielectric constant (Dk) of the polymer of this invention can be as low as 2.8 or lower and can be in the range of from about 2.2 to about 3.2 at a frequency of 10 GHz. The low loss (Df) of the polymer can be lower than 0.0015, and may range from about 0.001 to 0.002. In addition, the polymer of this invention exhibits extremely high glass transition temperature (T_{g}), which can be higher than 250° C., and generally ranges from about 250° C. to 350° C. Even more importantly, the polymer of this invention readily binds with other crosslinkable materials as illustrated further below in various compositions made according to this invention. The compositions thus formed exhibit excellent peel strength, generally ranging from 6 to 8 N/cm, thus finding many applications for example as copper clad laminates.

Accordingly, in a further aspect of this invention there is also provided a composition comprising:
a) a polymer made according to this invention;
b) a crosslinking agent selected from the group consisting of:

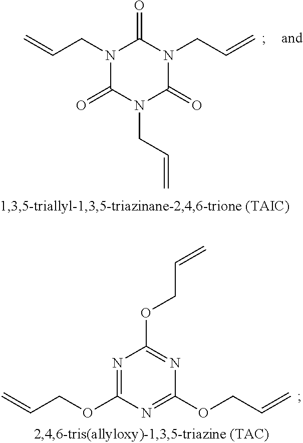

and
c) one or more additives selected from the group consisting of a tackifier and a free radical initiator.

As noted, any of the specific polymers within the general scope as described herein containing one or more monomers of formula (I) and at least one monomer of formula (II) can be employed in the composition of this invention. It should further be noted that the polymer contains at least four mole percent of repeat units of formula (IIA) derived from the corresponding monomer of formula (II) based on the total moles of repeat units of formulae (IA) and (IIA). In some embodiments, the composition of this invention contains a repeat units of formula (IIA) derived from the corresponding monomer of formula (II) in the amounts ranging from about five (5) mole percent to about forty (40) mole percent, from about ten (10) mole percent to about thirty (30) mole percent, from about fifteen (15) mole percent to about twenty-five (25) mole percent, and so on, based on total mole percent of repeat units of formulae (IA) and (IIA) present in the polymer. However, it should be noted that the polymer may contain lower than four (4) mole percent or higher than forty (40) mole of the repeat units of formula (IIA) depending upon the intended application of the composition so formed. Accordingly, all such possible combinations of mole percent of repeat units of formula (IIA) is within the scope of this invention.

Any amount of the crosslinking agents, TAIC or TAC, either taken alone, or in combination, can be used in the composition of this invention so as to bring about the intended benefit. Accordingly, in some embodiments the composition contains only TAIC as the crosslinking agent. In some other embodiments the composition contains only TAC as the crosslinking agent. In yet some other embodiments the composition contains a mixture of both TAIC and TAC as the crosslinking agents. Generally, the amount of TAIC or TAC used alone in the composition of this invention can range from about 5 to 20 parts per hundred parts of polymer (pphr), 8 to 18 pphr, 10 to 16 pphr, and so on. When a combination of TAIC and TAC are used in the composition the amounts of each can be same or different. The total amount of TAIC and TAC may be around 10 to 30 pphr, 15 to 25 pphr, and so on. Again, it should be noted that such amounts can be higher or lower depending upon the intended use of the composition.

As noted, the composition according to this invention contains a tackifier. Generally, the purpose of the tackifier is not only to increase the adhesiveness of the composition but also to improve the softness of the composition especially while fabricating at temperatures higher than 130° C. so that the composition may have some flow to impregnate the glass cloth or to fuse with other layers of the device. The composition of this invention can generally be crosslinked at a temperature higher than 130° C., and it is beneficial to keep the composition soft at this temperature. Accordingly, any of the tackifiers that would bring about this benefit can be used in the compositions of this invention. In addition, the amount of tackifier used can also vary depending on the intended use. Generally, such amounts can range from about 5 to 30 parts per hundred parts of polymer (pphr), 8 to 25 pphr, 10 to 20 pphr, and so on. It should be noted that a combination of two or more tackifiers can also be used in the composition of this invention. In such situations the combined amount can be adjusted in order to provide the intended benefit.

Non-limiting examples of such tackifiers that are suitable in the composition of this may be enumerated as follows:

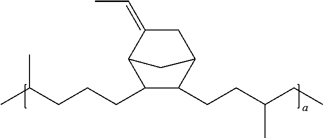

ethylene-propylene-ethylidenenorbornene terpolymer, where a is at least 100 (commercially available as TRILENE® T67 from Lion Elastomers);

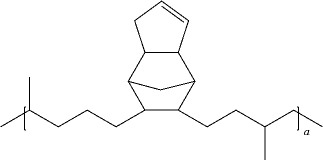

ethylene-propylene-dicyclopentadiene terpolymer, where a is at least 100 (commercially available as TRILENE® T65 from Lion Elastomers);

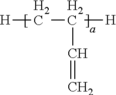

1,2-butadiene rubber, where a is at least 100 (commercially available as B1000 from Nisso America);

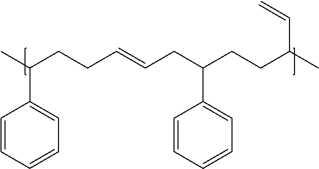

partially hydrogenated styrene/butadiene rubbers 1 (commercially available from Asahi Kasei as Tuftec P1083);

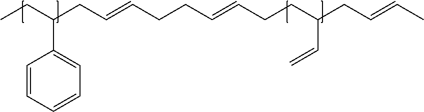

partially hydrogenated styrene/butadiene rubbers 2 (commercially available from Asahi Kasei as Tuftec 1500);

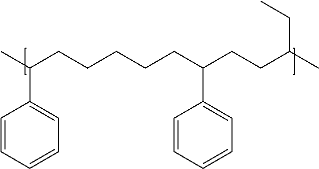

hydrogenated styrene/butadiene rubbers 1 (commercially available from Asahi Kasei as Tuftec H 1052); and

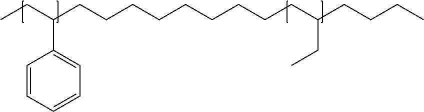

hydrogenated styrene/butadiene rubbers 2.

As noted, the composition of this invention further contains a free radical generator. Any free radical generator which will bring about the crosslinking reaction with the polymer and other components present in the composition and which facilitates adhesion to other suitable substrate such as for example copper and/or glass cloth can be used in the composition of this invention. Again, any amount of free radical generator can be used which will bring about the intended benefit. Such amounts may vary and for example can range from about 1 pphr to 6 pphr of the free radical initiator.

Non-limiting examples of the free radical generator that can be used in the composition of this invention include the following:

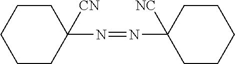 [SMILES: N#CC1(N=NC2(C#N)CCCCC2)CCCCC1]

1,1′-(diazene-1,2-diyebis(cyclohexane-1-carbonitrile) (commercially available as V-40 from Sigma Aldrich);

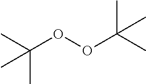

di-tert-butyl peroxide;

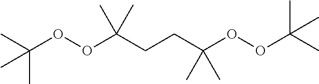 [SMILES: CC(C)(C)OOC(C)(C)CCC(C)(C)OOC(C)(C)C]

2,5-bis(tert-butylperoxy)-2,5-dimethylhexane (Luperox-101);

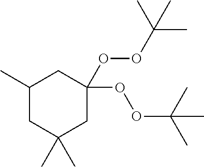 [SMILES: CC1CC(C)(C)CC(OOC(C)(C)C)(OOC(C)(C)C)C1]

1,1-bis(tert-butylperoxy)-3,3,5-trimethylcyclohexane (Luperox-231);

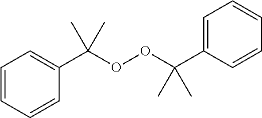 [SMILES: CC(C)(OOC(C)(C)c1ccccc1)c1ccccc1]

dicumyl peroxide (DCP, commercially available from Sigma Aldrich);

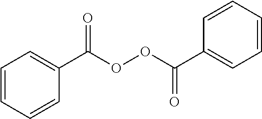 [SMILES: O=C(OOC(=O)c1ccccc1)c1ccccc1]

benzoyl peroxide;

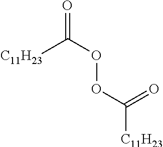

dodecanoic peroxyanhydride (Luperox-LP);

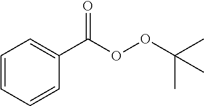

tert-butyl benzoperoxoate (Luperox-P); and

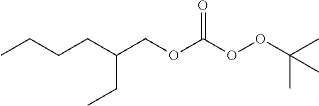 [SMILES: CCCCC(CC)COC(=O)OOC(C)(C)C]

tert-butyl (2-ethylhexyl) carbonoperoxoate (Luperox-TBEC).

As noted, any of the polymers as described herein can be employed in the composition of this invention. Generally, the composition of this invention is dissolved in a suitable solvent to form a homogeneous solution. Such suitable solvents may be the same as the one enumerated above for forming the polymers of this invention. Generally, such solvents to form the composition of this invention include for example, aromatic solvents such as toluene, mesitylene, xylenes, hydrocarbon solvents such as decalin, cyclohexane and methyl cyclohexane, ether solvent such as tetrahydrofuran (THF), ester solvent such as ethyl acetate, and a mixture in any combination thereof.

Non-limiting examples of the composition according to this invention are selected from the group consisting of:
a solution containing a mixture of a terpolymer of norbornene (NB), 5-butylbicyclo[2.2.1]hept-2-ene (BuNB) and 5-(but-3-en-1-yl)bicyclo [2.2.1]hept-2-ene (ButenylNB); 1,3,5-triallyl-1,3,5-triazinane-2,4,6-trione (TAIC) and dicumyl peroxide (DCP);
a solution containing a mixture of a terpolymer of norbornene (NB), 5-butylbicyclo[2.2.1]hept-2-ene (BuNB) and 5-(but-3-en-1-yl)bicyclo[2.2.1]hept-2-ene (ButenylNB); 1,3,5-triallyl-1,3,5-triazinane-2,4,6-trione (TAIC), 1,2-butadiene rubber (B1000) and dicumyl peroxide (DCP);
a solution containing a mixture of a terpolymer of norbornene (NB), 5-butylbicyclo[2.2.1]hept-2-ene (BuNB) and 5-(but-3-en-1-yl)bicyclo[2.2.1]hept-2-ene (ButenylNB); 1,3,5-triallyl-1,3,5-triazinane-2,4,6-trione (TAIC), 1,2-butadiene rubber (B1000), poly-aryl ether cross linker end capped with methacrylate groups (SA9000) and dicumyl peroxide (DCP);
a solution containing a mixture of a terpolymer of norbornene (NB), 5-butylbicyclo[2.2.1]hept-2-ene (BuNB) and 5-(cyclohex-3-en-1-yl)bicyclo[2.2.1]hept-2-ene (CyclohexeneNB); 1,3,5-triallyl-1,3,5-triazinane-2,4,6-trione (TAIC), 1,2-butadiene rubber (B1000) and dicumyl peroxide (DCP);

a solution containing a mixture of a copolymer of norbornene (NB) and 5-(but-3-en-1-yl)bicyclo[2.2.1]hept-2-ene (ButenylNB); 1,2-butadiene rubber (B1000) and dicumyl peroxide (DCP);
a solution containing a mixture of a copolymer of norbornene (NB) and 5-(but-3-en-1-yl)bicyclo[2.2.1]hept-2-ene (ButenylNB); ethylene-propylene-dicyclopentadiene terpolymer (T65) and dicumyl peroxide (DCP);
a solution containing a mixture of a copolymer of norbornene (NB) and 5-(but-3-en-1-yl)bicyclo[2.2.1]hept-2-ene (ButenylNB); ethylene-propylene-ethylidenenorbornene terpolymer (T67) and dicumyl peroxide (DCP);
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 1,3,5-triallyl-1,3,5-triazinane-2,4,6-trione (TAIC), 1,2-butadiene rubber (B1000) and dicumyl peroxide (DCP);
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 1,2-butadiene rubber (B1000) and dicumyl peroxide (DCP);
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 1,2-butadiene rubber (B1000), ethylene-propylene-ethylidenenorbornene terpolymer (T67) and dicumyl peroxide (DCP);
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 1,3,5-triallyl-1,3,5-triazinane-2,4,6-trione (TAIC), 1,2-butadiene rubber (B1000), ethylene-propylene-ethylidenenorbornene terpolymer (T67) and dicumyl peroxide (DCP); and
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 2,4,6-tris(allyloxy)-1,3,5-triazine (TAC), 1,2-butadiene rubber (B1000) and dicumyl peroxide (DCP).

In general, the composition in accordance with the present invention encompass a polymer as described herein containing one or more distinct monomers of formula (I), and at least one monomer of formula (II) in small quantities, as it will be seen below, various composition embodiments are selected to provide properties to such embodiments that are appropriate and desirable for the use for which such embodiments are directed, thus such embodiments are tailorable to a variety of specific applications. Accordingly, in some embodiments the composition of this invention encompasses a polymer containing more than two distinct monomers of formula (I), such as for example, three different monomers of formula (I) or four different monomers of formula (I) along with any desirable amount of monomer of formula (II), which can be as low as four mole percent as noted above.

For example, as already discussed above, by employing proper combination of different monomers of formula (I) it is now possible to tailor a composition having the desirable low dielectric properties and thermo-mechanical properties, among other properties. In addition, it may be desirable to include other polymeric or monomeric materials which are compatible to provide desirable low-loss and low dielectric properties depending upon the end use application as further discussed in detail below.

Even more advantageously, it has now been found that employing at least one monomer of formula (II), surprisingly, even in small amounts it is now possible to form crosslink structures within the polymeric framework in combination with the crosslinking agent as described herein. That is, crosslinks can occur inter-molecular (i.e., between two cross-linkable sites on different polymer chains as well as intra-molecular (i.e., between two cross-linkable sites on the same polymer chain). Statistically, this can happen, and all such combinations are part of this invention. By forming such inter-molecular or intra-molecular crosslinks the polymers formed from the composition of this invention provide hitherto unobtainable properties. This may include for example improved thermal properties. That is, much higher glass transition temperatures than observed for non-crosslinked polymers of similar composition. In addition, such crosslinked polymers are more stable at higher temperatures, which can be higher than 350° C. High temperature stability can also be measured by well-known thermogravimetric analysis (TGA) methods known in the art. One such measurement includes a temperature at which the polymer loses five percent of its weight (T_{d5}). As will be seen below by specific examples that follow the T_{d5} of the polymers formed from the composition of this invention can generally be in the range from about 330° C. to about 420° C. or higher. In some embodiments, the T_{d5} of the polymers formed from the composition of this invention is in the range from about 360° C. to about 400° C.

The compositions in accordance with the present invention may further contain optional additives as may be useful for the purpose of improving properties of both the composition and the resulting object made therefrom. Such optional additives for example may include anti-oxidants and synergists. Any of the anti-oxidants that would bring about the intended benefit can be used in the compositions of this invention. Non-limiting examples of such antioxidants include pentaerythritol tetrakis(3-(3,5-di-tert-butyl-4-hydroxyphenyl)propionate) (IRGANOX™ 1010 from BASF), 3,5-bis(1,1-dimethylethyl)-4-hydroxy-octadecyl ester benzenepropanoic acid (IRGANOX™ 1076 from BASF) and thiodiethylene bis[3-(3,5-di-tert.-butyl-4-hydroxy-phenyl)propionate] (IRGANOX™ 1035 from BASF). Non-limiting examples of such synergists include certain of the secondary antioxidants which may provide additional benefits such as for example prevention of autoxidation and thereby degradation of the composition of this invention and extending the performance of primary antioxidants, among other benefits. Examples of such synergists include, tris(2,4-ditert-butylphenyl)phosphite, commercially available as IRGAFOS 168 from BASF, various diamine synergists such as for example, N,N′-di-2-naphthyl-1,4-phenylenediamine, among others. Another synergist which may be suitable as an additive in the composition of this include certain diesters, such as for example, didodecyl 3,3′-thiodipropionate, whose structure is shown below:

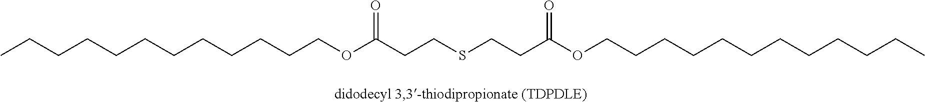 [SMILES: CCCCCCCCCCCCOC(=O)CCSCCC(=O)OCCCCCCCCCCCC]

Accordingly, the composition of this invention can be formed into films simply by following any of the known film casting techniques, including, for example, doctor blading, drum rolling, extrusion and/or spin coating, among other known methods. Accordingly, there is further provided a film formed from the composition of this invention. For example, any of the composition of this invention can be doctor-bladed onto a suitable substrate such as for example a glass plate. The coated plate is then heated to suitable temperature in an inert atmosphere to remove any residual solvent. Such temperatures can range from about 80° C. to 150° C. or 120° C. to 140° C. Suitable inert atmosphere can be nitrogen or argon. The heating at these temperatures for sufficient length of time will remove all of the residual solvent, for example a time interval of about 45 minutes to about 75 minutes. This initial stage of film forming is generally called as B-staged films. Under these conditions the film is still soluble in a suitable solvent such as for example THF, and is not fully crosslinked. The B-staged films are then further heated to higher temperature, which can range from about 150° C. to 220° C. or 160° C. to 190° C. in an inert atmosphere for sufficient length of time in order to affect the crosslinking of the film. Generally, such heating is carried out for about 90 minutes to 150 minutes to ensure full crosslinking of the composition, which is confirmed by insolubility of the polymer film.

The film thus formed in accordance with this invention exhibits unusually low dielectric constant, low loss, low coefficient of thermal expansion (CTE) and high glass transition temperature. In some embodiments the film formed according to this invention exhibits a dielectric constant (Dk) less than 3, less than 2.8, less than 2.6, less than 2.5, less than 2.4, less than 2.3, less than 2.2 at a frequency of 10 GHz, a glass transition temperature (T_{g}) in the range from about 150° C. to 280° C. or higher. In some other embodiments the T_{g} can be higher than 150° C., higher than 200° C., higher than 250° C. In yet some other embodiments the film according to this invention exhibits coefficient of thermal expansion (CTE) in the range of from about 80 ppm/K to 120 ppm/K, and a CTE less than 50 ppm/K when composited with glass cloth.

The film according to this invention can be formed from any of the specific embodiment of the composition as enumerated hereinabove. In a further aspect of this invention there is also provided a film formed from the polymer of this invention.

In a further embodiment, the film according to this invention exhibits a dielectric constant (Dk) less than 3 at a frequency of 10 GHz, a glass transition temperature higher than 150° C. and a coefficient of thermal expansion (CTE) less than 50 ppm/K.

It should additionally be noted that the crosslinked polymers formed from the composition of this invention may form thermosets thus offering additional advantages especially in certain applications where thermoplastics are not desirable. For example, any of the applications where higher temperatures are involved the thermoplastic polymers become less desirable as such polymeric materials may flow and are not suitable for such high temperature applications. Such applications include millimeter wave radar antennas as contemplated herein, among other applications.

Advantageously it has further been found that the low dielectric properties of the films formed from the composition of this invention can be improved by incorporating one or more filler materials. The filler materials can either be organic or inorganic. Any of the known filler materials which bring about the intended benefit can be used herein.

Accordingly, in some embodiments, the film forming composition according to this invention comprises an inorganic filler. Suitable inorganic filler is the one which has a coefficient of thermal expansion (CTE) lower than that of the film formed from the composition of this invention. Non-limiting examples of such inorganic filler includes oxides such as silica, alumina, diatomaceous earth, titanium oxide, iron oxide, zinc oxide, magnesium oxide, metallic ferrite; hydroxides such as aluminum hydroxide, magnesium hydroxide; calcium carbonate (light and heavy); magnesium carbonate, dolomite (anhydrous calcium magnesium carbonate mineral); carbonates; sulfates such as calcium sulfate, barium sulfate, ammonium sulfate, and calcium sulfite; talc, mica; clay; glass fibers; calcium silicate; montmorillonite; silicates such as bentonite; borates such as zinc borate, barium metaborate, aluminum borate, calcium borate, and sodium borate; carbon black; carbon such as carbon fibers; iron powder; copper powder; aluminum powder; zinc oxide; molybdenum sulfide; boronic fibers; potassium titanate; and lead zirconate. Various inorganic filler materials are commercially available, for example, silica nano particles are available as SC₂₃₀₀-SVJ from Adamatech Co. Ltd., and a ceramic filler, Lithafrax-2121, is available from St. Gobain, among many other filler materials that may be suitable for using with the composition of this invention.

In some other embodiments the film forming composition according to this invention further comprises an organic filler, which is generally a synthetic resin maybe in the form of a powder or can be in any other suitable form or a polymer. Examples of such polymeric fillers include without any limitation, poly(α-methylstyrene), poly(vinyl-toluene), copolymers of α-methylstyrene and vinyl-toluene, and the like. Further examples of such synthetic resin powder include powders of various thermosetting resins or thermoplastic resins such as alkyd resins, epoxy resins, silicone resins, phenolic resins, polyesters, acrylic and methacrylic resins, acetal resins, polyethylene, polyethers, polycarbonates, polyamides, polysulfones, polystyrenes, polyvinyl chlorides, fluororesins, polypropylene, ethylene-vinyl acetate copolymers, and powders of copolymers of these resins. Other examples of the organic filler include aromatic or aliphatic polyamide fibers, polypropylene fibers, polyester fibers, aramid fibers, and the like.

In some embodiments the filler is an inorganic filler. Thus, the coefficient of thermal expansion can be effectively reduced. Further, heat resistance can be improved. Accordingly, in some embodiments the inorganic filler is silica. Thus, the thermal expansion coefficient can be reduced while the dielectric characteristic is improved. Various forms of silica fillers are known in the art and all of such suitable silica fillers can be used in the composition of this invention. Examples of such silica filler include without any limitation fused silica, including fused spherical silica and fused crushed silica, crystalline silica, silica nano particles, and the like. In some embodiments the filler employed is silica nano particles. Surprisingly, it has now been observed that by employing suitable amounts of silica nano particles it is now possible to form composition which exhibits very low dielectric constant and very low loss properties. In some embodiments, by employing suitable silica nanoparticles in the amounts of about 60 pphr to 80 pphr, the dielectric constant (Dk) can be reduced to as low as 2.25 or lower and low loss (Df) of about 0.0009. In some other embodiments the Dk is 2.3 and Df is about 0.001. Generally, the amount of filler material can vary from about 5 weight percent to 80 weight percent or higher. In some embodiments, the content of the filler in the composition is from about 30 to 80 weight percent, based on the total solid content of the composition when polymerized to form film/sheet as described herein. By appropriately adjusting the content of the filler, the balance between the dielectric property and the coefficient of thermal expansion (CTE) can be improved. In some other embodiments, the content of the filler in the composition is from about 40 to 70 weight percent, based on the total solid content of the composition.

In general, the filler is treated with a silane compound having an alkoxysilyl group and an organic functional group such as an alkyl group, an epoxy group, a vinyl group, a phenyl group and a styryl group in one molecule. Such silane compounds include, for example, a silane having an alkyl group such as ethyltriethoxysilane, propyltriethoxysilane or butyltriethoxysilane (alkylsilane), a silane having a phenyl group such as phenyltriethoxysilane, benzyltriethoxysilane or phenethyltriethoxysilane, a silane having a styryl group such as styryltrimethoxysilane, butenyltriethoxysilane, propenyltriethoxysilane or vinyltrimethoxysilane (vinylsilane), a silane having an acrylic or methacrylic group such as γ-(methacryloxypropyl) trimethoxysilane, a silane having an amino group such as γ-aminopropyltriethoxysilane, N-β(aminoethyl)-γ-aminopropyltrimethoxysilane, N-phenyl-γ-aminopropyltrimethoxysilane or an epoxy group such as γ-(3,4-epoxycyclohexyl) ureido triethoxysilane, and the like. Silanes having a mercapto group such as γ-mercaptopropyltrimethoxysilane or the like can also be used. It should further be noted that one or more of the aforementioned silane compounds can be used in any combination.

It should further be noted that, when an inorganic filler is used as the filler, the filler is generally treated with a “nonpolar silane compound.” Thus, the adhesion between the cyclic olefin polymer formed from the composition of this invention and the filler can be improved. As a result, the mechanical characteristics of the molded body can be improved. Advantageously, it has now been observed that treatment with a “nonpolar silane compound” can eliminate or reduce adverse effects on dielectric properties. As used herein, “nonpolar silane compound” refers to a silane compound having no polar substituent. Polar substituents refer to groups that can be hydrogen-bonded or ionically dissociated. Such polar substituents include, but are not limited to, —OH, —COOH, —COOM, NH₃, NR₄⁺A⁻, —CONH₂, and the like. Where, M is a cation such as an alkali metal, an alkaline earth metal or a quaternary ammonium salt, R is H or an alkyl group having 8 or less carbon atoms, and A is an anion such as a halogen atom.

In some embodiments, the surface of the filler is modified with a vinyl group. It is advantageous to employ a vinyl group as it is a non-polar substituent, thus providing much needed low dielectric properties. In order to modify the surface of the filler with a vinyl group, for example, vinylsilane can be used. Specific examples of the vinylsilane are as described hereinabove.

In general, the average particle size of the filler used is in the range from about 0.1 to 10 μm. In some embodiments, it is from about 0.3 to 5 μm, and in some other embodiments it is from about 0.5 to 3 μm. The average particle size is defined as the average diameter of the particles as measured by the light scattering method. When more than one type of filler is used, the average particle diameter of one or more of such fillers is still within the aforementioned numerical range. Since the average particle diameter of the filler is suitably small, the specific surface area of the filler is reduced. As a result, the number of polar functional groups which may adversely affect the dielectric properties is reduced, and the dielectric properties are easily improved. In addition, when the average particle diameter of the filler is suitably small, it is easy to polymerize and form the films from the composition of this invention. Even more importantly, the films/sheets so formed exhibit much needed uniform thickness and flatness as is needed in many of the intended applications.

The composition of the present invention may contain components other than those described above. The components other than the above include a coupling agent, a flame retardant, a release agent, an antioxidant, and the like. Non-limiting examples of the coupling agent include, silane coupling agents, such as, vinylsilanes, acrylic and methacrylic silanes, styrylsilanes, isocyanatosilanes, and the like. Adhesion between the composition of this invention and a base material or the like can be improved by using a silane coupling agent.

Non-limiting examples of the flame retardant include a phosphorus-based flame retardant such as trixylenyl phosphate, dixylenyl phosphate, 10-(2,5-dihydroxyphenyl)-10H-9-oxa-10 phosphaphenanthrene-10-oxide, a halogen-based flame retardant such as a brominated epoxy resin, and an inorganic flame retardant such as aluminum hydroxide and magnesium hydroxide.

The composition of this invention may further include one or more compounds or additives having utility as, among other things, adhesion promoter, a surface leveling agent, a synergist, plasticizers, curing accelerators, and the like.

Surprisingly, it has now been found that employing one or more thermal free radical initiator as described herein it is now possible to accelerate the crosslinking of the polymer formed from the composition of this invention, resulting in a crosslinked polymer that exhibits much improved thermal properties. For example, both glass transition temperature (T_{g}) and temperature at which five weight percent weight loss occurs (T_{d5}) of the resulting polymer can be increased. Such increase in T_{g} can be substantial and can range from about 10° C. to 50° C. In some embodiments the T_{g} of the polymer is increased from 20° C. to 40° C. by employing suitable amounts of thermal free radical initiator. Similarly, the T_{d5} of the polymer can also be increased from about 3° C. to 10° C.

It should be noted that the composition of this invention can be formed into any shape or form and not particularly limited to film. Accordingly, in some embodiments the composition of this invention can be formed into a sheet. The thickness of the sheet is not particularly limited, but when the application as a dielectric material is considered, the thickness is, for example, 0.01 to 0.5 mm. In some other embodiments the thickness is from about 0.02 to 0.2 mm. The sheet so formed generally does not substantially flow at room temperature (25° C.). The sheet may be provided on an arbitrary carrier layer or may be provided alone. Examples of the carrier layer include a polyimide film or a glass sheet. Any other known peelable film substrates may be used as the carrier layer.

As described above, the film/sheet formed in accordance with this invention has good dielectric properties and can be tailored based on the types of components employed in the composition of this invention as described herein. In quantitative terms, the relative permittivity, i.e., the dielectric constant (Dk) of the film/sheet at a frequency of 10 GHz is from about 2.2 to 2.8. The dielectric loss tangent (Df) at a frequency of 10 GHz is from about 0.0004 to 0.002, and in some other embodiments it is from about 0.0009 to 0.0015. As a result, the composition of the present invention finds applications in a variety of devices where such low dielectric materials are needed, such as for example the dielectric polymeric layers used in the millimeter wave radar antenna used in automotive applications and various other terminal equipment used in 5G devices, among others. See for example, JP 2018-109090 and JP 2003-216823. An antenna is usually composed of an insulator and a conductor layer (for example, copper foil). The composition or sheet of the present invention can be used as a part or the whole of the insulator. The antenna using the composition or the sheet of the present invention as a part or the whole of the insulator has good high-frequency characteristics and reliability (durability). The use of such materials in printed circuit boards as Cu-clad laminates need high performance thermosets having high glass transition temperatures, low coefficients of thermal expansion (CTE), low Dk/Df, high peel strength on Cu and good reliability at high temperature storage. The ability to form prepreg (composite with glass cloth), B-staging capability (generate a layer of material that is not cross linked or partially cross linked) and film fusing capability for fabricating layered structures are also important. Most commercial materials available in this area have not attained all these properties, especially low Dk/Df and high glass transition temperature.

The conductor layer in the antenna is formed of, for example, a metal having desirable conductivity. A circuit is formed on the conductor layer by using a known circuit processing method. Conductors forming the conductor layer include various metals having conductivity, such as gold, silver, copper, iron, nickel, aluminum, or alloy metals thereof. As a method for forming the conductor layer, a known method can be used. Examples include vapor deposition, electroless plating, and electrolytic plating. Alternatively, the metal foil (for example, copper foil) may be pressure-bonded by thermocompression bonding. The metal foil constituting the conductor layer is generally a metal foil used for electrical connection. In addition to the copper foil, various metal foils such as gold, silver, nickel, and aluminum can be used. It may also comprise an alloy foil substantially (for example, 98 wt % or more) composed of these metals. Among these metal foils, a copper foil is commonly used. The copper foil may be either a rolled copper foil or an electrolytic copper foil.

Advantageously, the composition of this invention fills the gap not hitherto attainable by the prior art materials. That is, as noted above, the compositions of this invention not only exhibit much needed low Dk/Df properties but also provides very high thermally stable materials as demonstrated by very high T_{g} and very high T_{d5} properties as discussed hereinabove.

Even more importantly the compositions of this invention can be formed into films/sheets of desirable thickness for forming various prepregs with glass cloth for fabricating into copper clad laminates. In some embodiments the film thickness of the films formed from the composition of this invention can be in the range of from about 75 to 150 microns, 90 to 120 microns suitable for forming metal clad laminates. In some embodiments the thickness can be lower than 75 microns or higher than 150 microns.

It should further be noted that various dielectric materials used in the applications mentioned herein must also withstand very harsh temperature conditions and must retain their dielectric properties for a long duration of time. Surprisingly, the films formed in accordance with this invention retain such low dielectric properties for a long period of time of up to 1000 hours or longer even when kept at high temperatures of about 125° C. or higher, thus providing additional benefit. The change of Dk or Df is very low, which can be as low as 3 percent or as low as one percent. Accordingly, in some embodiments of this invention the films formed in accordance with this invention retain substantially their Dk/Df properties for a period of 1000 hours or more at a temperature in the range of about 120° C. to 150° C. or higher.

As noted, the composition of this invention is generally used as such to form a film or sheet. In addition, the composition of this invention can also be used as a low molecular weight varnish-type material for certain applications. The weight average molecular weight of the polymer used in such application can be as low as 1,000 or 2,000 or 3,000 or can be less than 10,000. In such applications suitable amount of the desirable solvents can be added so as to maintain the solid content of the composition to about 10 to 70 weight percent when polymerized. Again, any of the solvents that are suitable to form such solutions can be used as a single solvent or a mixture of solvents as is needed for such application.

Advantageously, it has now been found that employing a mixture of low molecular weight polymer and a high molecular weight polymer as described herein provides best performance in controlling the resin flow during fabrication of the copper clad laminates. That is, an optimum flow for improved processing of the copper clad laminates can be achieved, which not only provides uniform copper clad laminated layer but also retain good properties after curing. Accordingly, in some embodiments low molecular weight polymer having a weight average molecular weight less than 5,000, less than 4,000, less than 3,000, less than 2,000 or less than 1,000 is combined with a high molecular weight polymer having a weight average molecular weight higher than 80,000; higher than 90,000; higher than 100,000 or higher than 150,000 or higher to form a composition in accordance of this invention. Any of the amount of low molecular weight polymer as described herein can be used for this purpose which results in intended benefit. In some embodiments the amount of low molecular weight polymer employed in the composition of this invention can range from about ten (10) weight percent to about forty (40) weight percent or twenty (20) weight percent to about thirty (30) weight percent based on the total amount of low and high molecular weight polymer employed. As one of skill in the art may readily appreciate employing too low amounts of low molecular weight polymer may not wet the glass cloth or the copper surface completely. At the same time employing high amounts of low molecular weight polymer may plasticize the surface and the polymer (i.e., resin) may flow profusely which is undesirable. Accordingly, employing optimum amounts of the low and high molecular weight polymer mixture in the composition can provide the intended benefit as is apparent from the specific examples that follow.

In a further aspect of this invention there is provided a kit for forming a film. There is dispensed in this kit a composition of this invention. Accordingly, in some embodiments there is provided a kit in which there is dispensed a polymer as described herein, one or more crosslinking agents as described herein, a tackifier, a free radical generator as described herein; and one or more optional additives as described herein. In some embodiments the kit of this invention contains a polymer having two distinct monomers of formula (I) and a monomer of formula (II) in combination with at least one each of a crosslinking agent, tackifier, free radical generator and an optional additive so as to obtain a desirable result and/or for intended purpose.

In another aspect of this embodiment of this invention the kit of this invention forms B-stageable film when subjected to suitable temperature for a sufficient length of time. That is to say that the composition of this invention is poured onto a surface or onto a substrate which needs to be encapsulated and exposed to suitable thermal treatment in order for the monomers to undergo polymerization to form a solid polymer which could be in the form of a film, or a sheet as described herein.

Generally, as already noted above, such polymerization can take place at various temperature conditions, such as for example heating, which can also be in stages, for example heating to 90° C., then at 110° C., and finally at 150° C. for sufficient length of time, for example 5 minutes to 2 hours at each temperature stage. The B-stages film can be further heated to higher than 150° C. for various lengths of time such as from 90 minutes to 150 minutes so as to cure the film to form a crosslinked polymeric network. By practice of this invention, it is now possible to obtain polymeric films on such substrates which are substantially uniform films. The thickness of the film can be as desired and as specifically noted above, and may generally be in the range of 50 to 500 microns or higher.

While making a sheet and to secure the flatness of the sheet and suppressing unintended shrinkage, various heating methods known to make sheet materials may be employed. For example, it is possible to heat at a relatively low temperature at first, and then gradually raise the temperature. In order to ensure flatness or the like, heating may be performed by pressurizing with a flat plate (metal plate) or the like before heating and/or by pressurizing with a flat plate. The pressure used for such pressurization may be, for example, 0.1 to 8 MPa, and in some other embodiments it may range from about 0.3 to 5 MPa.

In some embodiments, the kit as described herein encompasses various exemplary compositions as described hereinabove.

In yet another aspect of this invention there is further provided a method of forming a film for the fabrication of a variety of optoelectronic and/or automotive devices comprising:
forming a homogeneous clear composition comprising a polymer as described herein; one or more crosslinking agent as described herein; a tackifier as described herein; a free radical initiator as described herein; and optionally one or more additives, including a filler as described herein;
coating a suitable substrate with the composition or pouring the composition onto a suitable substrate to form a film; and
heating the film in stages to a suitable temperature to cause formation of the B-stageable film and a cured film.

The coating of the desired substrate to form a film with the composition of this invention can be performed by any of the coating procedures as described herein and/or known to one skilled in the art, such as by spin coating. Other suitable coating methods include without any limitation spraying, doctor blading, meniscus coating, ink jet coating and slot coating. The mixture can also be poured onto a substrate to form a film. Suitable substrates include any appropriate substrate as is, or may be used for electrical, electronic, or optoelectronic devices, for example, a semiconductor substrate, a ceramic substrate, a glass substrate.

Next, the coated substrate is baked, i.e., heated to facilitate the removal of solvent and cross linking, for example to a temperature from 50° C. to 150° C. for about 1 to 180 minutes, although other appropriate temperatures and times can be used. That is, first forming the film by a B-stage process to remove any solvent present and then partially curing, and in a subsequent step at a higher temperature fully curing. In some embodiments the substrate is baked at a temperature of from about 100° C. to about 120° C. for 120 minutes to 180 minutes. In some other embodiments the substrate is baked at a temperature of from about 110° C. to about 140° C. for 60 minutes to 120 minutes. That is, these are the B-staged films. Finally, the B-staged films thus formed are further heated to temperatures higher than about 150° C. to fully cure the film.

The films thus formed are then evaluated for their electrical properties using any of the methods known in the art. For example, the dielectric constant (Dk) or permittivity and dielectric loss tangent at a frequency of 10 GHz was measured using a device for measuring the permittivity by the cavity resonator method (manufactured by AET, conforming to JIS C 2565 standard). The coefficient of thermal expansion (CTE) was measured using a thermomechanical analysis apparatus (made by Seiko Instruments, SS 6000) in accordance with a measurement sample size of about 4 mm (width)×40 mm (Length)×0.1 mm (thickness), a measurement temperature range of 30˜350° C., and a temperature rising rate of 5° C./min. The coefficient of linear expansion from 50° C. to 100° C. was adopted as the coefficient of linear expansion. Generally, the films formed according to this invention exhibit excellent dielectric and thermal properties and can be tailored to desirable dielectric and thermal properties as described herein.

Accordingly, in some of the embodiments of this invention there is also provided a film or sheet obtained by the composition as described herein. In another embodiment there is also provided an electronic device comprising the film/sheet of this invention as described herein.

The composition of this invention can also be formed into a variety of composite structures which can be used as prepreg materials in the fabrication of metal clad laminates. Various types of metals can be used for this purpose, including for example copper, aluminum, stainless steel, among others. Metal clad lamination is well known in the art where layers of metal are cladded with insulation materials, such as for example the composition of this invention. For example, the compositions of this invention can be impregnated onto a glass fabric and then formed into a prepreg in a B-stage process by heating to suitable temperatures as described herein. Then the prepregs thus formed are sandwiched between layers of copper or other metal foil and cured at a temperature higher than 150° C. to form copper clad laminates.

It has now been found that the laminates thus formed in accordance with this invention exhibits excellent peel strength. That is, the cured films of this invention are so strongly bonded to either the glass surface or the metal surface it is difficult to peel the film from such substrates. Even more advantageously, it has now been surprisingly found that the peel strength can be increased by using optimum levels of the free radical initiator. For example, use of very low levels, i.e., less than 0.5 pphr of the free radical initiator can result in the composition exhibiting unacceptable peel strength. Whereas, use of free radical initiator in the range of about 2 to 3 pphr can provide surprisingly excellent peel strength. Accordingly, in some embodiments the peel strength of the composites formed in accordance with this invention can range from about 5 N/cm to about 8 N/cm or 9 N/cm or 11 N/cm or 13 N/cm or even higher depending upon the optimal amounts of free radical initiator used therein and the type of composite that is being made.

Accordingly, in some embodiments there is provided a glass cloth composite film/cloth (i.e., a prepreg) formed from the polymer of this invention, which exhibits a dielectric constant (Dk) less than 2.8 at a frequency of 10 GHz, a peel strength higher than 6 N/cm and a coefficient of thermal expansion (CTE) less than 40 ppm/K.

Advantageously, it has been further observed that the compositions of this invention can be coated uniformly onto a variety of glass or metal surfaces before curing such that any voids in the surface of such materials are fully covered. Then the coated surface is cured at a higher temperature to form a fully cured insulating layer, which is firmly bonded to such glass or metal surface. That is, for example, it is now possible to provide a metal foil with a coating of this composition to produce a printed wiring board or metal clad laminate in which the adhesion property between the insulating layer (i.e., the film formed from the composition of this invention), and the metal layer is excellent, and the loss at the time of signal transmission is further reduced.

Even more advantageously, it has now been found that the composition of this invention when applied onto a suitable surface can still flow and fill the voids before the two layers are well bonded. This is especially advantageous in the fabrication of metal clad laminates such as copper clad laminates where it is essential that all voids are completely insulated so as to further minimize loss at the time of signal transmission. Accordingly, in one aspect of this invention there is provided a method for producing a prepreg or a metal-clad laminate where a suitable glass fabric or a metal foil is coated with a composition of this invention and heated to suitable temperature in the range of from about 80° C. to 120° C. to form an uncured film of the composition of this invention on such glass fabric and/or metal foil. The composites thus formed are then cured at a higher temperature in the range of from about 160° C. to 180° C. to form fully cured laminates It should particularly be noted that the polymers used in this aspect of the invention can be of very low molecular weight. That is, the weight average molecular weight (M_{w}) of the polymers employed in this aspect of the invention can be as low as 1,000 or can be in the range from about 1,000 to 5,000. The compositions of this invention exhibit excellent flow properties before they are fully cured and fill the surfaces uniformly on such glass fabric or metal foil, thus providing excellent insulating layer exhibiting very low dielectric constant and low loss properties as described herein.

The following examples are detailed descriptions of methods of preparation and use of certain compounds/monomers, polymers, and compositions of the present invention. The detailed preparations fall within the scope of, and serve to exemplify, the more generally described methods of preparation set forth above. The examples are presented for illustrative purposes only, and are not intended as a restriction on the scope of the invention. As used in the examples and throughout the specification the ratio of monomer to catalyst is based on a mole-to-mole basis.

### EXAMPLES

### General

The following abbreviations have been used hereinbefore and hereafter in describing some of the compounds, instruments and/or methods employed to illustrate certain of the embodiments of this invention:
NB—bicyclo[2.2.1]hept-2-ene; HexNB—5-hexylbicyclo[2.2.1]hept-2-ene; BuNB—5-butylbicyclo[2.2.1]hept-2-ene; ButenylNB—5-(but-3-en-1-yl)bicyclo[2.2.1]hept-2-ene; CyHexeneNB—5-(cyclohex-3-en-1-yl)bicyclo[2.2.1]hept-2-ene; HexenylNB—5-(hex-5-en-1-yl)bicyclo[2.2.1]hept-2-ene; VNB—5-vinylbicyclo[2.2.1]hept-2-ene; ENB—5-ethylidenebicyclo[2.2.1]hept-2-ene; Pd785—palladium (II) bis(tricyclohexylphosphine) diacetate; Pd1206—(acetonitrile)bis(triisopropylphosphine)palladium(acetate) tetrakis(pentafluorophenyl)borate; Pd601—palladium diacetate diadamantyl-(n-butyl)phosphine(H₂O); Pd1602—[Pd(OAc)(MeCN)(PAd₂-n-Bu)₂]B(C₆F₅)₄; DANFABA—dimethylanilinium tetrakis(pentafluorophenyl)borate; LiFABA—lithium tetrakis(pentafluorophenyl)borate diethyl etherate; TAIC—1,3,5-triallyl-1,3,5-triazinane-2,4,6-trione; TAC—2,4,6-tris(allyloxy)-1,3,5-triazine; V-40—1,1′-(diazene-1,2-diyl)bis(cyclohexane-1-carbonitrile); DCP—dicumyl peroxide; B1000—1,2-butadiene rubber; T65—ethylene-propylene-dicyclopentadiene terpolymer; T67—ethylene-propylene-ethylidenenorbornene terpolymer; SA9000—poly-aryl ether cross linker end capped with methacrylate groups; SC₂₃₀₀-SVJ—silica nano particles; Irganox-1076—3,5-bis(1,1-dimethylethyl)-4-hydroxy-octadecyl ester benzenepropanoic acid; Irgafos-168—tris(2,4-ditert-butylphenyl)phosphite; BCO—bicyclo[4.2.0]oct-7-ene; TES—triethylsilane; MCH—methylcyclohexane; EA—ethyl acetate; THF—tetrahydrofuran; GPC—gel permeation chromatography; M_{w}—weight average molecular weight; Mₙ—number average molecular weight; PDI—polydispersity index; NMR—nuclear magnetic resonance spectroscopy; DSC—differential scanning calorimetry; TGA—thermogravimetric analysis; TMA—thermomechanical analysis; pphr—parts per hundred parts resin, i.e., the polymer according to this invention and as specifically described hereinbelow.

Various monomers as used herein are either commercially available or can be readily prepared following the procedures as described in U.S. Pat. No. 9,944,818.

### Example A

### Terpolymer of NB/HexNB/CyHexeneNB (60/20/20 Molar Ratio)

A mixture of NB (10.2 g, 109 mmol, as 75 weight percent solution in toluene), HexNB (6.46 g, 36 mmol), CyHexeneNB (6.32 g, 36 mmol), TES (8.43 g, 72 mmol), ethanol (0.84 g, 18 mmol) and DANFABA (0.09 g, 0.11 mmol) was dissolved in anhydrous toluene (222 g) taken in a glass reactor and flushed with nitrogen. This solution was heated to 80° C. in a nitrogen atmosphere. Pd1206 (0.04 g, 0.04 mmol, 0.9 wt. % solution in anhydrous ethyl acetate) was added to this solution. The heating of the mixture at 80° C. while stirring was continued for 4 hours. Toluene was then added to the reaction mixture. The diluted polymerized mixture was cooled to room temperature and poured to excess iso-propanol while stirring rapidly to precipitate the polymer. The liquids filtered out and the solids were dried in a vacuum oven at 50° C. to obtain the purified polymer. GPC (THF): M_{w}=3,140, Mₙ=1,410, PDI=2.2.

### Example B

### Copolymer of NB/CyHexeneNB (85/15 Molar Ratio)

A mixture of NB (14.5 g, 154 mmol, as 75 weight percent solution in toluene), CyHexeneNB (4.74 g, 27 mmol), TES (8.43 g, 72 mmol), ethanol (0.83 g, 18 mmol) and DANFABA (0.09 g, 0.11 mmol) were dissolved in anhydrous toluene (192 g) taken in a glass reactor and flushed with nitrogen. This solution was heated to 80° C. in a nitrogen atmosphere. Pd1206 (0.04 g, 0.04 mmol, 1.0 wt. % solution in anhydrous ethyl acetate) was added to this solution. The heating of the mixture at 80° C. while stirring was continued for 4 hours. Toluene was then added to the reaction mixture. The diluted polymerized mixture was cooled to room temperature and poured to excess iso-propanol while stirring rapidly to precipitate the polymer. The liquids filtered out and the solids were dried in a vacuum oven at 50° C. to obtain the purified polymer. GPC (THF): M_{w}=3,650, Mₙ=1,230, PDI=3.

### Example C

### Copolymer of NB/VNB (85/15 Molar Ratio)

A mixture of NB (14.5 g, 154 mmol, as 75 weight percent solution in toluene), VNB (3.27 g, 27 mmol), TES (8.43 g, 72 mmol), ethanol (0.84 g, 18 mmol) and DANFABA (0.09 g, 0.11 mmol) were dissolved in anhydrous toluene (182 g) taken in a glass reactor and flushed with nitrogen. This solution was heated to 80° C. in a nitrogen atmosphere. Pd1206 (0.04 g, 0.04 mmol, 1.0 wt. % solution in anhydrous ethyl acetate) was added to this solution. The heating of the mixture at 80° C. while stirring was continued for 4 hours. Toluene was then added to the reaction mixture. The diluted polymerized mixture was cooled to room temperature and poured to excess iso-propanol while stirring rapidly to precipitate the polymer. The liquids filtered out and the solids were dried in a vacuum oven at 50° C. to obtain the purified polymer. GPC (THF): M_{w}=4,130, Mₙ=1,480, PDI=2.8.

### Example D

### Terpolymer of NB/HexNB/HexenylNB (60/20/20 Molar Ratio)

A mixture of NB (11.3 g, 120 mmol, as 75 weight percent solution in toluene), HexNB (7.13 g, 40 mmol), HexenylNB (7.05 g, 40 mmol), BCO (8.65 g, 80 mmol), and LiFABA (0.025 g, 0.03 mmol) were dissolved in anhydrous toluene (112 g) taken in a glass reactor and flushed with nitrogen. This solution was heated to 80° C. in a nitrogen atmosphere. Pd601 (0.06 g, 0.01 mmol, 0.7 wt. % solution in anhydrous THF) was added to this solution. The heating of the mixture at 80° C. while stirring was continued for 4 hours. Toluene was then added to the reaction mixture. The diluted polymerized mixture was cooled to room temperature and poured to excess iso-propanol while stirring rapidly to precipitate the polymer. The liquids filtered out and the solids were dried in a vacuum oven at 50° C. to obtain the purified polymer. GPC (THF): M_{w}=4,240 Mₙ=1,700, PDI=2.5.

### Example 1

### Terpolymer of NB/HexNB/CyHexeneNB (50/25/25 Molar Ratio)

A mixture of NB (5.64 g, 60 mmol), HexNB (5.34 g, 30 mmol), CyHexeneNB (5.22 g, 30 mmol), BCO (0.104 g, 0.96 mmol) and LiFABA (0.008 g, 0.01 mmol, 5 wt. % solution in anhydrous ethyl acetate) dissolved in anhydrous toluene (48 g) was placed in a crimp-capped vial sealed and flushed with nitrogen. The solution was heated to 90° C. Pd1602 (0.008 g, 0.005 mmol in a 1 wt. % solution in ethyl acetate) was added to this solution by syringe transfer. The heating of the solution at 90° C. while stirring continued for 6 hours. The polymerized mixture was cooled to room temperature and poured onto excess methanol (300 g) while stirring rapidly to precipitate the polymer. The liquid portion was decanted and the solid was washed with methanol (300 g) and dried in a vacuum oven at 80° C. for 24 hours to obtain the purified polymer (12.1 g, 79% isolated yield, GPC (THF): M_{w}=40,150, Mₙ=9,775, PDI=4.1.

### Example 2

### Terpolymer of NB/HexNB/ButenylNB (50/25/25 Molar Ratio)

A mixture of NB (5.64 g, 60 mmol), HexNB (5.34 g, 30 mmol), ButenylNB (4.44 g, 30 mmol), BCO (0.104 g, 0.96 mmol) and LiFABA (0.008 g, 0.01 mmol, 5 wt. % solution in anhydrous ethyl acetate) dissolved in anhydrous toluene (45 g) was taken in a crimp-capped vial, sealed, and flushed with nitrogen. The solution was heated to 90° C. Pd1602 (0.008 g, 0.005 mmol, one wt. % solution in ethyl acetate) was added to this solution by syringe transfer. The heating of the solution at 90° C. while stirring continued for 6 hours. The polymerized mixture was cooled to room temperature and poured onto excess methanol (300 g) while stirring rapidly to precipitate the polymer. The liquid portion was decanted and the solid was washed with methanol (300 g) and dried in a vacuum oven at 80° C. for 24 hours to obtain the purified polymer (13.2 g, 81% isolated yield, GPC (THF): M_{w}=95,550, Mₙ=25,130, PDI=4.1.

### Example 3

### Terpolymer of NB/BuNB/CyHexeneNB (40/35/25 Molar Ratio)

A mixture of NB (4.52 g, 48 mmol), BuNB (6.3 g, 42 mmol), CyHexeneNB (5.22 g, 30 mmol), BCO (0.104 g, 0.96 mmol) and LiFABA (0.008 g, 0.01 mmol, 5 wt. % solution in anhydrous ethyl acetate) dissolved in anhydrous toluene (62 g) was taken in a crimp-capped vial, sealed, and flushed with nitrogen. The solution was heated to 90° C. Pd1602 (0.008 g, 0.005 mmol, one wt. % solution in ethyl acetate) was added to this solution by syringe transfer. The heating of the mixture at 90° C. while stirring was continued for 6 hours (GPC (THF): M_{w}=126,063, Mₙ=35,337, PDI=3.6. The polymerized mixture was cooled to room temperature and poured to excess methanol (400 mL) while stirring rapidly to precipitate the polymer. The liquid portion was decanted and the solid was washed with methanol (400 mL) and dried in a vacuum oven at 80° C. for 24 hours to obtain the purified polymer (9.4 g, 57% isolated yield).

### Example 4

### Terpolymer of NB/BuNB/ButenylNB (40/35/25 Molar Ratio)

A mixture of NB (4.52 g, 48 mmol), BuNB (6.3 g, 42 mmol), ButenylNB (4.44 g, 30 mmol), BCO (0.104 g, 0.96 mmol) and LiFABA (0.008 g, 0.01 mmol, 5 wt. % solution in anhydrous ethyl acetate) dissolved in anhydrous toluene (59 g) was taken in a crimp-capped vial, sealed, and flushed with nitrogen. The solution was heated to 90° C. Pd1602 (0.008 g, 0.005 mmol, one wt. % solution in ethyl acetate) was added to this solution by syringe transfer. The heating of the solution at 90° C. while stirring was continued for 6 hours (GPC (THF): M_{w}=33,775, Mₙ=8,400, PDI=4. The polymerized mixture was cooled to room temperature and poured to excess methanol (400 mL) while stirring rapidly to precipitate the polymer. The liquid portion was decanted and the solid was washed with methanol (400 mL) and dried in a vacuum oven at 80° C. for 24 hours to obtain the purified polymer (9 g, 59% isolated yield).

### Example 5

### Terpolymer of NB/HexNB/CyHexeneNB (50/25/25 Molar Ratio)

A mixture of NB (6.59 g, 70 mmol), HexNB (6.23 g, 35 mmol), CyHexeneNB (6.09 g, 35 mmol), BCO (0.122 g, 1.13 mmol) and LiFABA (0.018 g, 0.021 mmol, 5 wt. % solution in anhydrous ethyl acetate) dissolved in anhydrous toluene (43 g) was taken in a crimp-capped vial, sealed, and flushed with nitrogen. The solution was heated to 90° C. Pd1602 (0.011 g, 0.007 mmol, one wt. % solution in ethyl acetate) was added to this solution by syringe transfer. The heating of the mixture at 90° C. while stirring was continued for 6 hours. The polymerized mixture was cooled to room temperature and poured to excess methanol (400 g) while stirring rapidly to precipitate the polymer. The liquids decanted and the solids dissolved in a solvent of mixture of toluene (40 g) and THF (25 g). The solution was then poured into methanol (400 mL) while stirring to precipitate the polymer. The liquids decanted and the solids washed with methanol (400 g) and dried in a vacuum oven at 80° C. for 24 hours to obtain the purified polymer (14.7 g, 78% isolated yield, GPC (THF): M_{w}=73,950, Mₙ=16,550, PDI=4.5. The monomeric composition of the terpolymer (NB/HexNB/CyHexeneNB) was calculated to be 52/26/22 from ¹³C-NMR (CDCl₃) analysis.

### Example 6

### Terpolymer of NB/HexNB/CyHexeneNB (35/40/25 Molar Ratio)

A mixture of NB (4.28 g, 45.5 mmol), HexNB (9.26 g, 52 mmol), CyHexeneNB (5.66 g, 32.5 mmol), BCO (0.123 g, 1.05 mmol) and LiFABA (0.017 g, 0.02 mmol, 5 wt. % solution in anhydrous ethyl acetate) dissolved in anhydrous toluene (44 g) was taken in a crimp-capped vial, sealed, and flushed with nitrogen. The solution was heated to 90° C. Pd1602 (0.01 g, 0.007 mmol, one wt. % solution in ethyl acetate) was then added to this solution by syringe transfer. The heating of the solution at 90° C. while stirring was continued for 6 hours. The polymerized mixture was cooled to room temperature and poured to excess methanol (400 g) while stirring rapidly to precipitate the polymer. The liquids decanted and the solids dissolved in a solvent mixture of toluene (40 g) and THF (25 g). The solution was poured into methanol (400 mL) while stirring to precipitate the polymer. The liquids decanted and the solids washed with methanol (400 g) and dried in a vacuum oven at 80° C. for 24 hours to obtain the purified polymer (15 g, 78% isolated yield, GPC (THF): M_{w}=85,250, Mₙ=18,450, PDI=4.6. The monomeric composition of the terpolymer (NB/HexNB/CyHexeneNB) was calculated to be 39/40/21 from ¹³C-NMR (CDCl₃) analysis.

### Example 7

### Terpolymer of NB/HexNB/ButenylNB (35/40/25 Molar Ratio)

A mixture of NB (4.28 g, 45.5 mmol), HexNB (9.26 g, 52 mmol), ButenylNB (4.81 g, 32.5 mmol), BCO (0.06 g, 0.56 mmol) and LiFABA (0.017 g, 0.02 mmol, 5 wt. % solution in anhydrous ethyl acetate) dissolved in anhydrous toluene (42 g) was taken in a crimp-capped vial, sealed, and flushed with nitrogen. The solution was heated to 90° C. Pd1602 (0.010 g, 0.007 mmol, one wt. % solution in ethyl acetate) was added to this solution by syringe transfer. The heating of the solution at 90° C. while stirring was continued for 6 hours. The polymerized mixture was cooled to room temperature and poured to excess methanol (400 g) while stirring rapidly to precipitate the polymer. The liquids decanted and the solids dissolved in a solvent mixture of toluene (40 g) and THF (25 g). The solution was poured into methanol (400 mL) while stirring to precipitate the polymer. The liquids decanted and the solids washed with methanol (400 g) and dried in a vacuum oven at 80° C. for 24 hours to obtain the purified polymer (16 g, 87% isolated yield, GPC (THF): M_{w}=25,900, Mₙ=6,725, PDI=3.9. The monomeric composition of the terpolymer (NB/HexNB/CyHexeneNB) was calculated as 40/40/20 from ¹³C-NMR (CDCl₃) analysis.

### Example 8

### Terpolymer of NB/HexNB/CyHexeneNB (60/20/20 Molar Ratio)

A mixture of NB (8.47 g, 90 mmol), HexNB (5.34 g, 30 mmol), CyHexeneNB (5.22 g, 30 mmol), BCO (0.087 g, 0.81 mmol) and LiFABA (0.020 g, 0.023 mmol, 5 wt. % solution in anhydrous ethyl acetate) dissolved in anhydrous toluene (44 g) was taken in a crimp-capped vial, sealed, and flushed with nitrogen. The solution was heated to 90° C. Pd1602 (0.012 g, 0.008 mmol, one wt. % solution in ethyl acetate) was added to this solution by syringe transfer. The heating of the mixture at 90° C. while stirring was continued for 6 hours. The polymerized mixture was cooled to room temperature and poured to excess methanol (400 g) while stirring rapidly to precipitate the polymer. The liquids decanted and the solids washed with methanol (300 g) and dried in a vacuum oven at 80° C. for 24 hours to obtain the purified polymer (15 g, 78% isolated yield, GPC (THF): M_{w}=149,300, Mₙ=43,875, PDI=3.4. The monomeric composition of the terpolymer (NB/HexNB/CyHexeneNB) was calculated to be 60/20/20 from ¹³C-NMR (CDCl₃) analysis.

### Example 9

### Terpolymer of NB/HexNB/ButenylNB (60/20/20 Molar Ratio)

A mixture of NB (8.47 g, 90 mmol), HexNB (5.34 g, 30 mmol), ButenylNB (4.44 g, 30 mmol), BCO (0.052 g, 0.48 mmol) and DANFABA (0.018 g, 0.023 mmol, 5 wt. % solution in anhydrous ethyl acetate) dissolved in anhydrous toluene (42 g) was taken in a crimp-capped vial, sealed, and flushed with nitrogen. This solution was heated to 90° C. Pd1206 (0.009 g, 0.008 mmol, one wt. % solution in ethyl acetate) was added to this solution by syringe transfer. The heating of the mixture at 90° C. while stirring was continued for 6 hours. The polymerized mixture was cooled to room temperature and poured to excess methanol (300 g) while stirring rapidly to precipitate the polymer. The liquids decanted and the solids washed with methanol (300 g) and dried in a vacuum oven at 80° C. for 24 hours to obtain the purified polymer (17 g, 93% isolated yield. GPC (THF): M_{w}=23,075, Mₙ=6,250, PDI=3.7. The monomeric composition of the terpolymer (NB/HexNB/CyHexeneNB) was calculated to be 64/21/15 from ¹³C-NMR (CDCl₃) analysis.

### Example 10

### Terpolymer of NB/HexNB/CyHexeneNB (60/20/20 Molar Ratio)

A mixture of NB (112.9 g, 1200 mmol, as 75 weight percent solution in toluene), HexNB (71.3 g, 400 mmol), CyHexeneNB (69.7 g, 400 mmol), TES (2.05 g, 17.6 mmol), ethanol (9.2 g, 200 mmol) and LiFABA (0.26 g, 0.3 mmol) was dissolved in anhydrous toluene (972 g) taken in a glass reactor and flushed with nitrogen. This solution was heated to 80° C. in a nitrogen atmosphere. Pd601 (0.06 g, 0.1 mmol, 1.3 wt. % solution in anhydrous THF) was added to this solution. The heating of the mixture at 80° C. while stirring was continued for 6 hours. Toluene (1280 g) was then added to the reaction mixture. The diluted polymerized mixture was cooled to room temperature and poured in three batches of about 570 g each to excess iso-propanol (about 1400 g each) while stirring rapidly to precipitate the polymer. The liquids filtered out and the solids were dried in a vacuum oven at 80-90° C. for 20-30 hours to obtain the purified polymer. GPC (THF): M_{w}=146,150, Mₙ=58,749, PDI=2.5. The monomeric composition of the terpolymer (NB/HexNB/CyHexeneNB) was calculated to be 63/19/18 from ¹³C-NMR (CDCl₃) analysis.

### Example 10A

### Terpolymer of NB/HexNB/CyHexeneNB (60/20/20 Molar Ratio)

The terpolymer of Example 10A was prepared substantially following the procedures as set forth in Example 10. GPC (THF): M_{w}=140,600, Mₙ=44,777, PDI=3.1. The monomeric composition of the terpolymer (NB/HexNB/CyHexeneNB) was calculated to be 62/21/17 from ¹³C-NMR (CDCl₃) analysis.

### Example 10B

### Terpolymer of NB/HexNB/CyHexeneNB (60/20/20 Molar Ratio)

The terpolymer of Example 10B was prepared substantially following the procedures as set forth in Example 10. GPC (THF): M_{w}=174,000, Mₙ=57,237, PDI=3. The monomeric composition of the terpolymer (NB/HexNB/CyHexeneNB) was calculated to be 62/20/18 from ¹³C-NMR (CDCl₃) analysis.

### Example 11

### Terpolymer of NB/HexNB/CyHexeneNB (60/20/20 Molar Ratio)

A mixture of NB (113 g, 1200 mmol, as 75 weight percent solution in toluene), HexNB (71.3 g, 400 mmol), CyHexeneNB (69.7 g, 400 mmol), BCO (1.08 g, 10.0 mmol) and LiFABA (0.26 g, 0.3 mmol) was dissolved in anhydrous toluene (545 g) taken in a glass reactor and flushed with nitrogen. This solution was heated to 80° C. in a nitrogen atmosphere. Pd1602 (0.16 g, 0.1 mmol, 1.3 wt. % solution in anhydrous ethyl acetate) was added to the reaction mixture. The heating of the mixture at 80° C. while stirring was continued for 6 hours. THF (850 g) was then added to the reaction mixture. The diluted polymerized mixture was cooled to room temperature and poured in three batches of about 560 g each to excess methanol (about 2700 g each) while stirring rapidly to precipitate the polymer. The liquids were filtered out and the solids were dried in a vacuum oven at 80-90° C. for 20-30 hours to obtain the purified polymer (231 g, 91% isolated yield. GPC (THF): M_{w}=166,600, Mₙ=34,000, PDI=4.9. The monomeric composition of the terpolymer (NB/HexNB/CyHexeneNB) was calculated to be 64/19/17 from the ¹³C-NMR (CDCl₃) analysis.

### Example 12

### Terpolymer of NB/HexNB/CyHexeneNB (70/10/20 Molar Ratio)

A mixture of NB (131.8 g, 1400 mmol, as 75 wt. percent solution in toluene), HexNB (35.7 g, 200 mmol), CyHexeneNB (69.7 g, 400 mmol), BCO (1.62 g, 15 mmol) and LiFABA (0.26 g, 0.3 mmol) was dissolved in anhydrous toluene (899 g) taken in a glass reactor and flushed with nitrogen. This solution was heated to 80° C. in a nitrogen atmosphere. Pd1602 (0.16 g, 0.1 mmol, 1.3 wt. % solution in anhydrous ethyl acetate) was added to this solution. The heating of the mixture at 80° C. while stirring was continued for 6 hours. Toluene (1750 g) was then added to the reaction mixture. The diluted polymerized reaction mixture was cooled to room temperature and poured in three batches of about 570 g each to excess iso-propanol (about 2700 g each) while stirring rapidly to precipitate the polymer. The liquids were filtered out and the solids were dried in a vacuum oven at 80-90° C. for 20-30 hours to obtain the purified polymer (227 g, 96% isolated yield. GPC (THF): M_{w}=117,325, Mₙ=26,950, PDI=4.4. The monomeric composition of the terpolymer (NB/HexNB/CyHexeneNB) was calculated to be 70/10/20 from ¹³C-NMR (CDCl₃) analysis.

### Example 13

### Terpolymer of NB/HexNB/HexenylNB (60/20/20 Molar Ratio)

A mixture of NB (113 g, 1200 mmol, as 75 wt. percent solution in toluene), HexNB (71.3 g, 400 mmol), HexenylNB (70.5 g, 400 mmol), BCO (1.62 g, 15.0 mmol) and LiFABA (0.26 g, 0.30 mmol) dissolved in anhydrous toluene (976 g) was taken in a glass reactor and flushed with nitrogen. This solution was heated to 80° C. in a nitrogen atmosphere. Pd601 (0.06 g, 0.1 mmol, 1.3 wt. % solution in anhydrous THF) was added to this solution. The heating of the mixture at 80° C. while stirring was continued for 6 hours. Toluene (1280 g) was then added to the reaction mixture. The diluted polymerized mixture was cooled to room temperature and poured in three batches of about 570 g each to excess iso-propanol (about 2500 g each) while stirring rapidly to precipitate the polymer. The liquids were filtered out and the solids were dried in a vacuum oven at 80-90° C. for 20-30 hours to obtain the purified polymer. GPC (THF): M_{w}=169,775, Mₙ=39,625, PDI=4.3. The monomeric composition of the terpolymer (NB/HexNB/HexenylNB) was calculated to be 60/20/20 from ¹³C-NMR (CDCl₃) analysis.

### Example 13A

### Terpolymer of NB/HexNB/CyHexeneNB (40/40/20 Molar Ratio)

A mixture of NB (33.9 g, 360 mmol, as 75 wt. percent solution in toluene), HexNB (64.2 g, 360 mmol), CyHexeneNB (31.4 g, 180 mmol), BCO (1.27 g, 11.7 mmol), and LiFABA (0.12 g, 0.14 mmol) was dissolved in anhydrous toluene (579 g) taken in a glass reactor and flushed with nitrogen. This solution was heated to 80° C. in a nitrogen atmosphere. Pd601 (0.027 g, 0.05 mmol, 0.6 wt. % solution in anhydrous THF) was added to this solution. The heating of the mixture at 80° C. while stirring was continued for 4 hours. Toluene (717 g) was then added to the reaction mixture. The diluted polymerized mixture was cooled to room temperature and added to excess iso-propanol (about 4800 g) while stirring rapidly to precipitate the polymer. The liquids filtered out and the solids were dried in a vacuum oven at 50-55° C. for about 12 hours followed by at 100° C. for about 4 hours to obtain the purified polymer (118.8 g, 92% isolated yield). GPC (THF): M_{w}=106,600, Mₙ=23,400, PDI=4.5. The monomeric composition of the terpolymer (NB/HexNB/CyHexeneNB) was calculated to be 44/41/15 from ¹³C-NMR (CDCl₃) analysis.

### Example 14

### Copolymer of NB/HexenylNB (75/25 Molar Ratio)

A mixture of NB (150.7 g, 1500 mmol, as 75 wt. percent solution in toluene), HexenylNB (88.2 g, 500 mmol), BCO (1.62 g, 15.0 mmol) and LiFABA (0.26 g, 0.30 mmol) dissolved in anhydrous toluene (825 g) was taken in a glass reactor and flushed with nitrogen. This solution was heated to 80° C. in a nitrogen atmosphere. Pd1602 (0.16 g, 0.1 mmol, 1.3 wt. % solution in anhydrous ethyl acetate) was added to this solution. The heating of the mixture at 80° C. while stirring was continued for 6 hours. Toluene (1156 g) was then added to the reaction mixture. The diluted polymerized mixture was cooled to room temperature and poured in three batches of about 550 g each to excess iso-propanol (about 3850 g each) while stirring rapidly to precipitate the polymer. The liquids were filtered out and the solids were dried in a vacuum oven at 80-90° C. for 20-30 hours to obtain the purified polymer (217 g, 91% yield). GPC (THF): M_{w}=162,318, Mₙ=32,780, PDI=5.

### Example 15

### Copolymer of NB/CyHexeneNB (80/20 Molar Ratio)

A mixture of NB (150.7 g, 160 mmol, as 75 wt. percent solution in toluene), CyHexeneNB (69.7 g, 400 mmol), BCO (1.62 g, 15 mmol) and LiFABA (0.26 g, 0.3 mmol) was dissolved anhydrous toluene (825 g) taken in a glass reactor and flushed with nitrogen. This solution was heated to 80° C. in a nitrogen atmosphere. Pd1602 (0.16 g, 0.1 mmol, 1.3 wt. % solution in anhydrous ethyl acetate) was added to this solution. The heating of the mixture at 80° C. while stirring was continued for 6 hours. Toluene (1152 g) was then added to the reaction mixture. The diluted polymerized mixture was cooled to room temperature and poured in three batches of about 570 g each to excess iso-propanol (about 3840 g each) while stirring rapidly to precipitate the polymer. The liquids were filtered out and the solids were dried in a vacuum oven at 80-90° C. for 20-30 hours to obtain the purified polymer (212 g, 96% yield). GPC (THF): M_{w}=28,275, Mₙ=8,950, PDI=3.2. The monomeric composition of the copolymer (NB/CyHexeneNB) was calculated to be 80/20 from ¹H-NMR (CDCl₃) analysis.

### Example 15A

### Copolymer of HexNB/CyHexeneNB (80/20 Molar Ratio)

A mixture of HexNB (128.4.2 g, 720 mmol), CyHexeneNB (31.4 g, 180 mmol), BCO (1.27 g, 11.7 mmol), and LiFABA (0.12 mmol, 0.14 mmol) was dissolved in anhydrous toluene (728 g) taken in a glass reactor and flushed with nitrogen. This solution was heated to 80° C. in a nitrogen atmosphere. Pd601 (0.027 g, 0.05 mmol, 0.6 wt. % solution in anhydrous THF) was added to this solution. The heating of the mixture at 80° C. while stirring was continued for 4 hours. Toluene (717 g) was then added to the reaction mixture. The diluted polymerized mixture was cooled to room temperature and added to excess iso-propanol (about 4700 g) while stirring rapidly to precipitate the polymer. The liquids filtered out and the solids were dried in a vacuum oven at 50-55° C. for about 9 hours followed by at 100° C. for about 4 hours. GPC (THF): M_{w}=92,600, Mₙ=25,000, PDI=3.7. The monomeric composition of the copolymer (HexNB/CyHexeneNB) was calculated to be 86/14 from ¹³C-NMR (CDCl₃) analysis.

### Example 16

### Copolymer of NB/VNB (80/20 Molar Ratio)

A mixture of NB (150.7 g, 160 mmol, as 75 wt. percent solution in toluene), VNB (48.1 g, 400 mmol), BCO (1.62 g, 15 mmol) and LiFABA (0.14 g, 0.16 mmol) was dissolved in anhydrous toluene (853 g) taken in a glass reactor and flushed with nitrogen. This solution was heated to 80° C. in a nitrogen atmosphere. Pd1602 (0.13 g, 0.08 mmol, 1.3 wt. % solution in anhydrous ethyl acetate) was added to this solution. The heating of the mixture at 80° C. while stirring was continued for 6 hours. Toluene (480 g) was then added to the reaction mixture. The diluted polymerized mixture was cooled to room temperature and poured in four batches of about 270 g each to excess iso-propanol (about 1350 g each) while stirring rapidly to precipitate the polymer. The liquids were filtered out and the solids were dried in a vacuum oven at 80-90° C. for more than 12 hours to obtain the purified polymer (98 g, 49% yield). GPC (THF): M_{w}=28,275, Mₙ=8,950, PDI=3.2. The monomeric composition of the copolymer (NB/VNB) was calculated to be 80/20 from1H-NMR (CDCl₃) analysis.

### Example 17

### Copolymer of NB/ENB (80/20 Molar Ratio)

A mixture of NB (150.7 g, 160 mmol, as 75 wt. percent solution in toluene), ENB (48.1 g, 400 mmol), BCO (1.62 g, 15 mmol) and LiFABA (0.14 g, 0.16 mmol) was dissolved in anhydrous toluene (853 g) taken in a glass reactor and flushed with nitrogen. This solution was heated to 80° C. in a nitrogen atmosphere. Pd1602 (0.13 g, 0.08 mmol, 1.3 wt. % solution in anhydrous ethyl acetate) was added to this solution. The heating of the mixture at 80° C. while stirring was continued for 6 hours. Toluene (480 g) was then added to the reaction mixture. The diluted polymerized mixture was cooled to room temperature and poured in four batches of about 270 g each to excess iso-propanol (about 1350 g each) while stirring rapidly to precipitate the polymer. The liquids decanted and the solids washed with iso-propanol (270 g) for each precipitation. The liquids were filtered out and the solids were dried in a vacuum oven at 80-90° C. for more than 12 hours to obtain the purified polymer (103 g, 52% yield). GPC (THF): M_{w}=73,300, Mₙ=17,550, PDI=4.2. The monomeric composition of the copolymer (NB/ENB) was calculated to be 80/20 from1H-NMR (CDCl₃) analysis.

### Example 18

### Copolymer of NB/ButenylNB (75/25 Molar Ratio)

A mixture of NB (8.47 g, 90 mmol, as 75 wt. percent solution in toluene), ButenylNB (4.44 g, 30 mmol), BCO (0.14 g, 1.29 mmol) and LiFABA (0.008 g, 0.01 mmol, 5 wt. % solution in ethyl acetate) was dissolved in anhydrous toluene (53 g) in a crimp-capped vial, sealed and flushed with nitrogen. This solution was heated to 90° C. in a nitrogen atmosphere. Pd1602 (0.0.008 g, 0.005 mmol, one wt. % solution in anhydrous ethyl acetate) was added to this solution by syringe transfer. The heating of the mixture at 90° C. while stirring was continued for 6 hours. The polymerized mixture was cooled to room temperature and poured into methanol (300 g) while stirring rapidly to precipitate the polymer. The liquids were filtered out and the solids were dried in a vacuum oven at 80° C. for 24 hours to obtain the purified polymer (12.5 g, 91% yield). GPC (THF): M_{w}=61,150, Mₙ=5,500, PDI=11.

### Examples 19A-19C

### Evaluation of Low Loss Film Properties

The terpolymer of Example 3 (terpolymer of NB/BuNB/CyHexeneNB, 40/35/25 molar ratio) was dissolved in mesitylene to prepare 16.6 wt. % solution. To three separate portions of this solution was added 15 pphr of TAIC (Example 19A), B1000 (Example 19B) and 15 pphr each of SA9000, TAIC and B1000 (Example 19C). A comparative composition was also prepared which contained only a portion of the polymer solution of Example 3 and 15pphr of SA9000 (Comparative Example 1). To each of these four compositions 4.5 pphr of DCP was added as the free radical initiator. Each one of these compositions were doctor-bladed on glass substrates and heated at 130° C. for 1 hour in an oven under nitrogen atmosphere to remove any residual solvent from the films. The solubility of these B-staged films was tested by sonicating small pieces of the films in THF for 1 hour. The B -staged films were further cured at 170° C. for 2 hours in an oven under nitrogen atmosphere to generate cured films having thickness in the range of about 75-150 μm. The solubility of these cured films was also tested by sonicating small pieces of the films in THF for 1 hour to ensure the films have lost the solubility due to cross linking to generate thermosets. The dielectric constant (Dk) and dielectric dissipation factor (Df) at 10 GHz were measured for each of the cured films. The results are summarized in Table 1. All of the films after the B-stage at 130° C. for 1 hour retained the solubility in THF (i.e., not cross linked) indicating the suitability of using these compositions in Cu-clad laminate fabrication processes. SA9000, TAIC and B1000 are capable of cross linking the films as observed by the loss of solubility in THF after the cure step indicating the suitability of generating thermosets from these compositions for Cu-clad laminates. The cross linker (TAIC) and the tackifier (B1000) used in this invention can generate cured films with low loss properties (i.e., low Dk and De but the commonly used poly-aryl ether cross linker end capped with methacrylate groups, SA9000, did not form films with low loss properties since Df was 0.0055 at 10 GHz (Comparative Example 1). However, the combination of SA9000 with TAIC and B1000 formed films with low loss properties.

TABLE 1

| | | Solubility | Solubility | | |
|---|---|---|---|---|---|
| | | in THF | in THF | | |
| Example No. | Additive | (B-staged) | (Cured) | Dk | Df |
| Comparative | SA9000 | Yes | No | 2.19 | 0.0055 |
| Example 1 | | | | | |
| Example 19A | TAIC | Yes | No | 2.21 | 0.0026 |
| Example 19B | B1000 | Yes | No | 2.44 | 0.0015 |
| Example 19C | SA9000, | Yes | No | 2.32 | 0.0020 |
| | TAIC, B1000 | | | | |

### Examples 20A-20C

### Evaluation of Low Loss Film Properties

The copolymer of Example 18 (NB/ButenylNB, 75/25 molar ratio) was dissolved in mesitylene to prepare 20 wt. % solution. To three separate portions of this solution were added 15 pphr of B1000 (Example 20A), 15 pphr of T65 (Example 20B) and 15 pphr of T67 (Example 20C). To each of these three compositions were also added 4 pphr of DCP as the free radical initiator. These compositions were doctor-bladed on glass substrates and heated at 130° C. for 1 hour in an oven under nitrogen atmosphere to remove any residual solvent from the films. The solubility of these B-staged films was tested by sonicating small pieces of the films in THF for 1 hour. The B -staged films were further cured at 170-180° C. for 1 hour followed by further 1 hour at 170-180° C. under vacuum to generate cured films having thickness of about 75-150 μm. The solubility of these cured films was also tested by sonicating small pieces of the films in THF for 1 hour to ensure the films have lost the solubility due to cross linking to generate thermosets. The dielectric constant (Dk) and dielectric dissipation factor (Df) at 10 GHz were measured for the cured films. The results are summarized in Table 2. All of the films after the B-stage at 130° C. for 1 hour retained the solubility in THF (i.e., not cross linked) indicating the suitability of using these compositions in Cu-clad laminate fabrication processes. All compositions are capable of cross linking as observed by the loss of solubility in THF after the cure step indicating the suitability of generating thermosets from these compositions for Cu-clad laminates. The results further demonstrate that the cross linker tackifiers (i.e., B1000, T65 and T67) employed in the composition of this invention can generate cured films exhibiting desirable low loss properties (i.e., low Dk and Df).

TABLE 2

| | | Solubility | Solubility | | |
|---|---|---|---|---|---|
| | | in THF | in THF | | |
| Example No. | Additive | (B-staged) | (Cured) | Dk | Df |
| Example 20A | B1000 | Yes | No | 2.16 | 0.00182 |
| Example 20B | T65 | Yes | No | 2.29 | 0.00196 |
| Example 20C | T67 | Yes | No | 2.04 | 0.00154 |

### Examples 21A-21B

### Evaluation of Low Loss and Thermal Properties of Films

The terpolymer of Example 3 (NB/BuNB/CyHexeneNB, 40/35/25 molar ratio) (Example 21A) and the terpolymer of Example 4 (NB/BuNB/ButenylNB, 40/35/25 molar ratio) (Example 21B) were dissolved in mesitylene to prepare 20 wt. % solutions. To individual portions of these two solutions were added 15 pphr B1000, 15 pphr TAIC and 5 pphr DCP. These compositions were then doctor-bladed separately on glass substrates. Solvents were removed by heating to 130° C. for 1 hour in an oven under nitrogen atmosphere followed by cure at 180° C. for 2 hours under vacuum to generate films having thickness in the range of about 75-150 μm. Glass transition temperature (T_{g}) and coefficient of thermal expansion (CTE) of these films were measured by TMA. Decomposition temperature at which the films lost 5 wt. % (T_{d5}) was measured by TGA. Dk and Df were also measured at 10 GHz. The results are summarized in Table 3. Excellent properties suitable for Cu-clad laminates for printed circuit boards that are suitable for devices such as mm-Wave Radar Antenna requiring low loss properties such as low Dk and Df, low CTEs that can be further lowered by incorporating suitable fillers, high T_{g} that is useful in high temperature processing and high decomposition temperatures (T_{d5}) needed for thermal stability of such devices are obtained.

TABLE 3

| Example No. | Dk | Df | CTE (ppm/K) | T_{g} (° C.) | T_{d5} (° C.) |
|---|---|---|---|---|---|
| Example 21A | 2.19 | 0.0015 | 82 | 338 | 338 |
| Example 21B | 2.20 | 0.0017 | 96 | 260 | 395 |

### Examples 22A-22D

### Evaluation of Low Loss and Thermal Properties of Films

The terpolymer of Example 1 (NB/HexNB/CyHexeneNB, 50/25/25 molar ratio) was dissolved in mesitylene to make 22 wt. % solution. To four separate portions of this solution were added 15 pphr B1000 (Example 22A), 15 pphr B1000 and 15 pphr TAIC (Example 22B), 15 pphr B1000, 10 pphr T67 (Example 22C), 20 pphr B1000, 5 pphr T67 and 10 pphr TAIC (Example 22D). To each of these four compositions was added DCP (4 pphr). Each one of these compositions were doctor-bladed on glass substrates. Solvents removed (B-staged) at 130° C. for 1 hour in an oven under nitrogen atmosphere. B-staged films were cured at 170-180° C. for 1 hour under nitrogen followed by 1 hour at 170 -180° C. under vacuum to generate films having thickness of about 75-150 μm. Glass transition temperature (T_{g}) and coefficient of thermal expansion (CTE) were measured by TMA. Decomposition temperature at which the film lost 5 wt. % (T_{d5}) was measured by TGA. Dk and Df were also measured at 10 GHz. The results are summarized in Table 4. Excellent properties suitable for Cu-clad laminates for printed circuit boards that are suitable for devices such as mm-Wave Radar Antenna requiring low loss properties such as low Dk and Df, low CTEs (Examples 22A, 22B and 22D) that can be further lowered by incorporating suitable fillers, high T_{g} that is useful in high temperature processing and high decomposition temperatures (T_{d5}) needed for thermal stability of such devices are obtained. The combination of additives such as B1000, TAIC and T67 as in Example 22D had superior performance in terms of low loss properties.

TABLE 4

| | | | CTE | T_{g} | T_{d5} |
|---|---|---|---|---|---|
| Example No. | Dk | Df × 10⁻³ | (ppm/K) | (° C.) | (° C.) |
| Example 22A | 2.29 ± 0.03 | 1.00 ± 0.03 | 100 | 285 | 388 |
| Example 22B | 2.20 ± 0.03 | 1.10 ± 0.03 | 104 | 204 | 390 |
| Example 22C | 2.11 ± 0.03 | 0.93 ± 0.03 | 160 | 271 | 389 |
| Example 22D | 2.07 ± 0.03 | 0.52 ± 0.03 | 106 | 299 | 397 |

### Examples 23A-23D

### Evaluation of Low Loss Film Properties at Different Levels of Tackifier

The terpolymer of Example 6 (NB/HexNB/CyHexeneNB, 35/40/25 molar ratio) and the terpolymer of Example 8 (NB/HexNB/CyHexeneNB, 60/20/20 molar ratio) were separately dissolved in mesitylene to prepare 25 wt. % solution (from terpolymer of Example 6) and 20 wt. % solution (from terpolymer of Example 8). To separate portions of these two solutions were added 20 pphr B1000, 10 pphr TAIC and 5 pphr T67 (designated as Composition A) and 20 pphr B1000, 10 pphr TAIC and 15 pphr T67 (designated as Composition B). To each of these two compositions were added different amounts of DCP as summarized in Table 5 to form a total of four different compositions. Each of these four compositions were doctor-bladed on glass substrates and heated to 130° C. for 1 hour in an oven under nitrogen atmosphere to remove solvents (B-staged). The films were cured at 175-180° C. for 1.5 hours under vacuum. Dk and Df at 10 GHz were measured for the cured films. The results are summarized in Table 5. The results as summarized in Table 5 suggests that employing 15 pphr of T67 is advantageous for attaining low Df, which is extremely desirable for low loss applications as described herein.

TABLE 5

| | Polymer | | | | | |
|---|---|---|---|---|---|---|
| Example | Example | | DCP | T67 | | Df × |
| No. | No. | Composition | (pphr) | (pphr) | Dk | 10⁻³ |
| Example | Example 6 | A | 1 | 5 | 2.28 ± | 0.74 ± |
| 23A | | | | | 0.04 | 0.04 |
| Example | Example 6 | B | 6 | 15 | 2.22 ± | 0.54 ± |
| 23B | | | | | 0.06 | 0.04 |
| Example | Example 8 | A | 2 | 5 | 2.16 | 0.89 |
| 23C | | | | | | |
| Example | Example 8 | B | 2 | 15 | 2.25 ± | 0.66 ± |
| 23D | | | | | 0.03 | 0.06 |

### Examples 24A-24B

### Evaluation of Glass Cloth Composites

The terpolymer of Example 13A (NB/HexNB/CyHexeneNB, 40/40/20 molar ratio) (For Example 24A) and the copolymer of Example 15A (HexNB/CyHexeneNB, 80/20 molar ratio) were each dissolved in decalin to prepare respectively 20 wt. % solutions. To portions of these solutions were added B1000 (20 pphr), T67 (15 pphr), TAIC (10 pphr) and DCP (2 pphr). These compositions were doctor-bladed on glass substrates and heated to 130° C. for 1 hour in an oven under nitrogen to remove the solvent. These B-staged films were cured at 190° C. for 1.5 hours under vacuum to obtain films having thickness of about 75-100 μm. Low Df glass fabric (NE glass cloth, style # 1280, 50 μm) were thoroughly wetted with these compositions to impregnate the glass cloth with this low loss composition. The glass fabric composites were heated to 130° C. for 1 hour under nitrogen in an oven to remove solvent and generate the prepreg. The prepreg were cured at 190° C. for 90 minutes under vacuum. Dk and Df of the cured film samples as well as the prepregs were measured at 10 GHz and listed in Table 6.

TABLE 6

| Example No. | Glass Cloth Composite | Dk at 10 GHz | Df at 10 GHz |
|---|---|---|---|
| Example 24A | No | 2.29 | 0.0002 |
| Example 24A | Yes | 2.60 | 0.0018 |
| Example 24B | No | 2.29 | 0.0004 |
| Example 24B | Yes | 2.64 | 0.0017 |

### Examples 25A-25D

### Evaluation of Low Loss and Thermal Properties of Films

The terpolymer of Example 10B (NB/HexNB/CyHexeneNB, 60/20/20 molar ratio) (for Example 25A), the terpolymer of Example 13 (NB/HexNB/HexenylNB, 60/20/20 molar ratio) (for Example 25B), the copolymer of Example 14 (NB/HexenylNB, 75/25 molar ratio) (for Example 25C) and the copolymer of Example 15 (NB/CyHexeneNB, 80/20 molar ratio) (for Example 25D) were each dissolved in decalin to prepare 20 wt. % solutions, respectively. To portions of these four solutions were added B1000 (20 pphr), T67 (15 pphr), TAIC (10 pphr), DCP (0.75 pphr for Examples 25A, 25C and 25D and 1.0 pphr for Example 25B), Irganox-1076 (1.75 pphr) and Irgafos-168 (0.6 pphr) to form four different compositions. Each of these compositions were doctor-bladed on glass substrates and heated to 130° C. for 1 hour in an oven under nitrogen to remove the solvent. These B-staged films were cured at 190° C. for 1.5 hours under vacuum to obtain films having thickness of: 90 μm (Example 25A), 110 μm (Example 25B), 85 μm (Example 25C) and 125 μm (Example 25D). Glass transition temperature (T_{g}) and coefficient of thermal expansion (CTE) were measured by TMA. Decomposition temperature at which the film lost 5 wt. % (T_{d5}) was measured by TGA. Dk and Df were measured at 10 GHz. The results are summarized in Table 7. Excellent properties suitable for Cu-clad laminates for printed circuit boards that are suitable for devices such as mm-Wave Radar Antenna requiring low loss properties such as low Dk and Df, low CTEs that can be further lowered by incorporating suitable fillers, high T_{g} that is useful in high temperature processing and high decomposition temperatures (T_{d5}) needed for thermal stability of such devices are obtained.

TABLE 7

| | Polymer | | | | | |
|---|---|---|---|---|---|---|
| Example | Example | | Df × | CTE | T_{g} | T_{d5} |
| No. | No. | Dk | 10⁻³ | (ppm/K) | (° C.) | (° C.) |
| Example 25A | Example 10A | 2.27 | 0.90 | 119 | 254 | 388 |
| Example 25B | Example 13 | 2.31 | 1.50 | 131 | 195 | 373 |
| Example 25C | Example 14 | 2.28 | 1.70 | 126 | 222 | 371 |
| Example 25D | Example 15 | 2.25 | 1.00 | 95 | 281 | 376 |

### Examples 26A-26C

### Comparative Low Loss and Thermal Properties of Films Containing Different Crosslinkers

The terpolymer of Example 10 (NB/HexNB/CyHexeneNB, 60/20/20 molar ratio) was dissolved in decalin to prepare 20 wt. % solution. To a portion of this solution was added B1000 (20 pphr), T67 (15 pphr), TAIC (10 pphr for Example 26A), TAC (10 pphr for Example 26B), DCP (2 pphr), Irganox-1076 (1.75 pphr) and Irgafos-168 (0.6 pphr). Additional amount of decalin (50-100 pphr) was also added to facilitate the dissolution of all of the components. These two compositions were doctor-bladed separately on glass substrates and heated to 130° C. for 1 hour in an oven under nitrogen to remove the solvent. A low Df glass fabric (NE glass cloth, Style # 1280, 50 μm) was thoroughly wetted with the composition of the Example 26A (for Example 26C) to impregnate the glass fabric. The treated glass fabric was then heated to 130° C. for 1 hour in an oven under nitrogen to remove the solvent. These B-staged films were cured at 190° C. for 1.5 hours under vacuum to obtain a film having a thickness of about 105 μm (Example 26A), a film having a thickness of about 70 μm (Example 26B) and a film having a thickness of about 90 μm. Glass transition temperature (T_{g}) and coefficient of thermal expansion (CTE) were measured by TMA. The CTE of the films from Examples 26A and 26B were measured at 50-100° C. temperature range and CTE of Example 26C was measured at 50-100° C. temperature range in xy direction since glass cloth composites gave lower Coefficients of thermal expansion over a wide range of temperatures. Decomposition temperature at which the film lost 5 wt. % (T_{d5}) was measured by TGA. The results are summarized in Table 8. It is quite evident from the results summarized in Table 8 that both TAIC and TAC are effective crosslinkers in the compositions of this invention to form films having low loss properties as well as excellent thermal properties.

TABLE 8

| | Cross | | | CTE | | |
|---|---|---|---|---|---|---|
| Example No. | Linker | Dk | Df × 10⁻³ | (ppm/K) | T_{g} (° C.) | T_{d5} (° C.) |
| Example 26A | TAIC | 2.28 | 0.80 | 128 | 258 | 361 |
| Example 26B | TAC | 2.29 | 0.80 | 128 | 257 | 376 |
| Example 26C | TAIC | 2.80 | 1.30 | <20 | >250 | 386 |

### Examples 27A-27B

### Evaluation of Films with Silica Nano Fillers

The terpolymer of Example 10A (NB/HexNB/CyHexeneNB, 60/20/20 molar ratio) was dissolved in decalin to prepare 20 wt. % solution. To a portion of this solution was added B1000 (20 pphr), T67 (15 pphr), TAIC (15 pphr), Irganox-1076 (1.5 pphr), Irgafos-168 (0.38 pphr) and silica nano particles (71 pphr of SC₂₃₀₀-SVJ). The composition thus formed was divided into two portions. To one of which compositions was added DCP (0.7 pphr) and was designated as Example 27A. To the other portion of the composition was added V-40 (1.25 pphr), designated as Example 27B. Additional amount of decalin (100 pphr) was also added to facilitate the dissolution of all of the components in each of these two compositions. These two compositions were then doctor-bladed separately on glass substrates and heated to 130° C. for 1 hour in an oven under nitrogen to remove the solvent. These B-staged films were cured at 190-195° C. for 1.5 hours under vacuum to obtain films having thickness of about 105 Dk of 2.24 and Df of 0.0009 was measured for the film formed from the composition of Example 27A at 10 GHz. Dk of 2.34 and Df of 0.0010 was measured for the film formed from the composition of Example 27B at 10 GHz.

### Examples 28A-28B

### Evaluation of Films with Ceramic Fillers

The terpolymer of Example 11 (NB/HexNB/CyHexeneNB, 60/20/20 molar ratio) was dissolved in decalin to prepare 20 wt. % solution. To a portion of this solution was added B1000 (20 pphr), T67 (15 pphr), TAIC (10 pphr), DCP (0.6 pphr), Irganox-1076 (1.75 pphr) and Irgafos-168 (0.6 pphr). Additional amount of decalin (50 pphr) was also added to facilitate the dissolution of formulation components. To portions of this composition was dispersed different levels of ceramic filler, Lithafrax-2121. These compositions were doctor-bladed on glass substrates and heated to 130° C. for 1 hour in an oven under nitrogen to remove the solvent. These B-staged films were cured at 190° C. for 1.5 hours under vacuum to obtain films having thickness of about 90-120 μm. Glass transition temperature (T_{g}) and coefficient of thermal expansion (CTE) were measured by TMA. Decomposition temperature at which the film lost 5 wt. % (T_{d5}) was measured by TGA. The results are summarized in Table 9. The incorporation of Lithafrax-2121 decreased CTE compared to a film that did not have a filler (Example 28A) and low CTE is desirable for the fabrication of Cu-clad laminates from these materials as observed for the compositions of Examples 28B and 28C.

TABLE 9

| | Film | Lithafrax- | CTE | T_{g} | T_{d5} |
|---|---|---|---|---|---|
| Example No. | Thickness | 2121 | (ppm/K) | (° C.) | (° C.) |
| Example 28A | 90 μm | None | 119 | 254 | 388 |
| Example 28B | 75 μm | 25 pphr | 107 | 257 | 409 |
| Example 28C | 100 μm | 75 pphr | 95 | 255 | 409 |

### Example 29

### Reliability Studies of Films at 125° C. Storage

Terpolymer of Example 10A (NB/HexNB/CyHexeneNB, 60/20/20 molar ratio) was dissolved in decalin to prepare 20 wt. % solution. To portions of this solution was added B1000 (20 pphr), TAIC (10 pphr), DCP (0.5 pphr), Irganox-1076 (1.5 pphr) and Irgafos-168 (0.38 pphr). Additionally, T67 (15 pphr) was added to Example 29A only. These two compositions were doctor-bladed on glass substrates and heated to 130° C. for 1 hour in an oven under nitrogen to remove the solvent. These B-staged films were cured at 190° C. for 1.5 hours under vacuum to obtain films having thickness of about 100 μm (Example 29A) and 95 μm (Example 29B). Dielectric constant (Dk) and dielectric dissipation factor Df were measured, and the films were placed in an oven at 125° C. under air. Periodic Dk and Df measurements were made at various time intervals up to 1000 hours of storage at 125° C. in air. FIG. 1 compares the Df vs. storage time plots for the films of Examples 29A, 29B, Comparative Example 2A and Comparative Example 2B. It is evident from FIG. 1 that the films of Examples 29A and 29B exhibit excellent reliability under these storage conditions that is required for devices consisting of the low loss parts for applications such as mm-Wave radar antenna for automotive industry since the devices must withstand harsh conditions during use. The early failure of the reliability testing of Comparative Examples 2A and 2B where B1000 and TAIC additives are removed confirms that TAIC is an essential component of this invention and B1000 is beneficial for generating films with good reliability at high temperature storage. In addition, FIG. 1 also shows that the film of Example 29B exhibits similar storage stability for low loss as that of Example 29A even though it did not contain T67. But Example 29A which contained T67 exhibits lower low loss properties at these storage conditions, thus demonstrating presence of T67 plays a beneficial role in lowering the Df. Dielectric constants (Dk) remained stable throughout the testing period of 1000 hours for Examples 29A and 29B as well as for Comparative Examples 2A and 2B as listed in Table 10 for initial Dk, average Dk during the testing time and the percent drop of Dk after full testing time.

TABLE 10

| | Full | | Average | Dk drop |
|---|---|---|---|---|
| | testing time | Initial | Dk during | after full |
| Example No. | (hrs.) | Dk | testing time | testing time |
| Example 29A | 1073 | 2.28 | 2.24 ± 0.03 | 3% |
| Example 29B | 1073 | 2.28 | 2.27 ± 0.02 | 1% |
| Comp. Example 2A | 1073 | 2.22 | 2.21 ± 0.02 | 1% |
| Comp. Example 2B | 667 | 2.29 | 2.29 ± 0.02 | <1% |

### Examples 30A-30C

### Reliability Studies of Films Formed Over Glass Cloth at 125° C. Storage

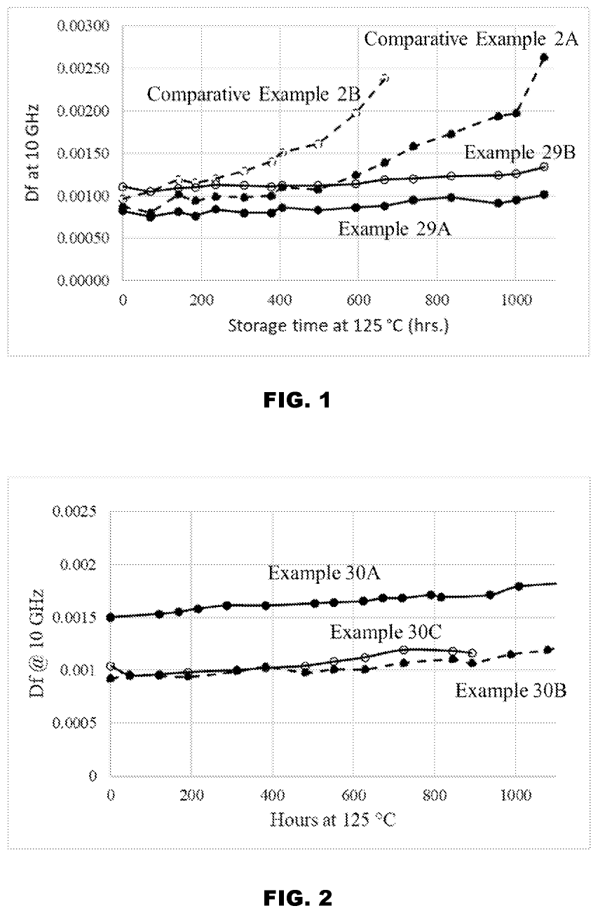

A low Df glass fabric (NE glass cloth, Style # 1280, 50 μm) was thoroughly wetted with the composition of Example 25A (Example 30A) to impregnate the glass fabric with the low loss composition of this invention. The treated glass fabric was heated to 130° C. for 1 hour in an oven under nitrogen to remove the solvent. This B-staged prepreg was cured at 190° C. for 1.5 hours under vacuum to obtain films at 210 μm thickness. The CTE of this glass cloth composite was measured by TMA at 150-250° C. temperature range at xy direction. The Dk and Df of the composite was measured at 10 GHz. Similarly, the cured composite films were formed from the composition of Example 27A (Example 30B) and the composition of Example 27B (Example 30C). All three films were placed in an oven at 125° C. under air. The Dk and Df measurements were made at various time intervals up to 1100 hours of storage at 125° C. in air. These films consisting of silica fillers (Examples 30B and 30C), or a glass fabric (Example 30A) are suitable to prepare prepreg in Cu-clad laminates for printed circuit boards have excellent reliability at 125° C. storage as shown in FIG. 2. Dielectric constant (Dk) remained stable throughout the testing period of up to 1100 hours for Examples 30A to 30C as listed in Table 11. FIG. 2 shows graphical illustration of the dielectric measurements over the period of over 1000 hours. It is again evident that all three films exhibited excellent stability of dielectric properties with marginal changes which can be attributed to variations in the measurements of the dielectric constant. Thus, the composition of this invention can be used in a variety of applications as described herein.

TABLE 11

| | Full | | Dk drop | |
|---|---|---|---|---|
| | testing time | | after full | |
| Example No. | (hrs.) | Initial Dk | testing time | CTE (ppm/K |
| Example 30A | 1008 | 2.64 | 1.5% | 39 |
| Example 30B | 1078 | 2.24 | 2.7% | |
| Example 30C | 892 | 2.34 | <1% | |

### Examples 31A-31B

### Reliability Studies at 85° C. and 85% Relative Humidity

The terpolymer of Example 11 (NB/HexNB/CyHexeneNB, 60/20/20 molar ratio) was dissolved in mesitylene to prepare 20 wt. % solution. To a portion of this solution was added B1000 (20 pphr), T67 (15 pphr), TAC (10 pphr), DCP (0.5 pphr), Irganox-1076 (1.75 pphr) and Irgafos-168 (0.5 pphr). Additional amount of mesitylene (50 pphr) was also added to facilitate the dissolution of all of the components to form a clear solution (Example 31A). A low Df glass fabric (NE glass cloth, Style # 1280, 50 μm) was thoroughly wetted (impregnated) with this composition to impregnate the glass cloth with this low loss composition. The glass fabric composite was heated to 130° C. for 1 hour under nitrogen in an oven to remove solvent and to form the prepreg.

The terpolymer of Example 10A (NB/HexNB/CyHexeneNB, 60/20/20 molar ratio) was dissolved in decalin to prepare 20 wt. % solution. To portions of this solution was added B1000 (20 pphr), T67 (15 pphr), TAIC (10 pphr), DCP (0.5 pphr), Irganox-1076 (1.75 pphr) and Irgafos-168 (0.5 pphr). Additional amount of decalin (50 pphr) was also added to facilitate the dissolution of all of the components to form a clear solution (Example 31B). This composition was doctor-bladed on a glass substrate and heated to 130° C. for 1 hour in an oven under nitrogen to remove the solvent.

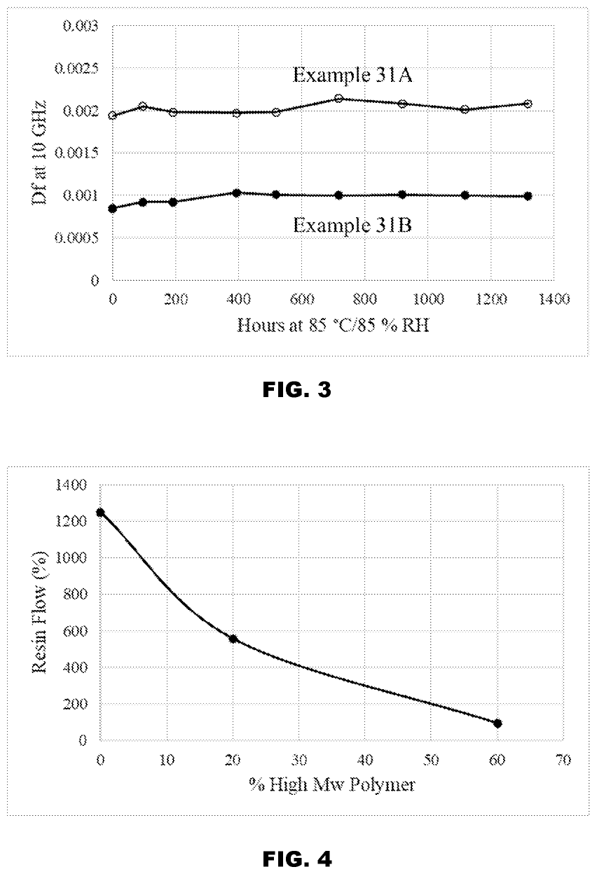

Both of these B-staged films were cured at 190° C. for 1.5 hours under vacuum to obtain films having thickness of 95 μm (Example 31A) and 105 μm (Example 31B). Dielectric constant (Dk) and dielectric dissipation factor Df were measured. These films were stored in an oven at 85° C. and 85% RH (relative humidity) for 1400 hours while measuring Dk and Df periodically. FIG. 3 shows the reliability of the cured films under these conditions. Both of these films either consisting of a glass cloth (Example 31A) or by itself (Example 31B) are suitable materials for Cu-clad laminates for printed circuit boards and exhibit excellent reliability at 85° C. and 85% RH storage as shown in FIG. 3. Dielectric constant (Dk) remained stable throughout the testing period of 1317 hours for Examples 31A and 31B as summarized in Table 12.

TABLE 12

| | Full testing | | Dk change after | CTE |
|---|---|---|---|---|
| Example No. | time (hrs.) | Initial Dk | full testing time | (ppm/K) |
| Example 31A | 1317 | 2.81 | −1.4% | <20 |
| Example 31B | 1317 | 2.31 | +1.7% | |

### Example 32

### Peel Strength Measurement

The terpolymer of Example 10A (NB/HexNB/CyHexeneNB, 60/20/20 molar ratio) was dissolved in decalin to prepare 20 wt. % solution. To portions of this solution were added B1000 (20 pphr), T67 (15 pphr), TAIC (10 pphr), Irganox-1076 (1.75 pphr) and Irgafos-168 (0.75 pphr). Various amounts of DCP was added as listed in Table 13. Additional amount of decalin (100 pphr) was also added to facilitate the dissolution of all of the components to form a clear solution. A thin layer of the composition was applied to a strip (about 2 cm×7 cm) of Cu foil (Mitsui, CF-14X-SV-18) and a low Df glass cloth (NE glass cloth, Style # 1280, 50 μm) was placed on the liquid and thoroughly wetted with the composition. The glass cloth composite on the Cu foil was heated to 130° C. for 1 hour under nitrogen in an oven to remove solvent followed by the cure step at 190° C. for 1.5 hours under vacuum. The peel strengths of the samples made on Cu foils were measured using Instron at 90-degree tilt. The peel strengths were calculated based on the average load of the highest five peaks and summarized in Table 13. High peel strengths suitable for copper clad laminates were obtained for Examples 32A, 32B and 32C compared to the Comparative Example 3 where lower loading of DCP (0.5 pphr) was used.

TABLE 13

| Example No. | DCP loading | Peel Strength |
|---|---|---|
| Comparative | 0.5 pphr | 2.7 N/cm |
| Example 3 | | |
| Example 32A | 1.0 pphr | 5.5 N/cm |
| Example 32B | 2.0 pphr | 7.6 N/cm |
| Example 32C | 4.0 pphr | 6.4 N/cm |

### Example 33

### Peel Strength Measurement

The terpolymer of Example 10A (NB/HexNB/CyHexeneNB, 60/20/20 molar ratio) was dissolved in decalin to prepare 20 wt. % solution. To portions of this solution was added B1000 (20 pphr), T67 (15 pphr), TAIC (10 pphr), DCP (0.5 pphr), Irganox-1076 (1.75 pphr) and Irgafos-168 (0.75 pphr). A thin layer of the formulation was applied to a strip (about 2 cm×7 cm) of Cu foil (Mitsui, CF-14X-SV-18) and heated to 130° C. for 1 hour under nitrogen in an oven to remove solvent followed by the cure step at 190° C. for 1.5 hours under vacuum. The peel strength of the sample made on Cu foil was measured using Instron at 90-degree tilt. The peel strength of 6.5 N/cm was calculated based on the average load of the highest five peaks. This again demonstrates that high peel strength suitable for copper clad laminates can be obtained employing the compositions of this invention.

### Examples 34A-34B

### Peel Strength Measurement of Glass Cloth Composites

A thin layer of the compositions of Example 24A (Example 34A) and the composition 24B (Example 34B) were applied to strips (about 1 cm×6 cm) of Cu foil (Mitsui, CF-14X-SV-18) and a low Df glass cloths (NE glass cloth, Style # 1280, 50 μm) were placed on the liquid and wetted with the respective compositions. The glass cloth composites on the Cu foils were then heated to 130° C. for 1 hour under nitrogen in an oven to remove solvent followed by the cure step at 190° C. for 1.5 hours under vacuum. The peel strengths of the samples made on Cu foils were measured using Instron at 90-degree tilt. The peel strengths were calculated based on the average load of the highest five peaks. High peel strengths suitable for copper clad laminates were obtained for Example 34A (12.6 N/cm) and Example 34B (11.2 N/cm).

### Example 35

### Peel Strength Measurement of Glass Cloth Composites

The terpolymer of Example 10B (NB/HexNB/CyHexeneNB, 60/20/20 molar ratio) was dissolved in decalin to prepare 15 wt. % solution. To portions of this solution were added B1000 (20 pphr), T67 (15 pphr), TAIC (10 pphr) DCP (2.0 pphr), Irganox-1076 (1.75 pphr) and Irgafos-168 (0.60 pphr). Additional amount of decalin (50 pphr) was also added to facilitate the solubility of all of the components. This composition was mixed by rolling overnight. A thin layer of the composition was applied to a strip (about 2 cm×7 cm) of Cu foil (Mitsui, CF-14X-SV-18) and heated to 130° C. for 1 hour under nitrogen in an oven to remove solvent followed by the cure step at 190° C. for 1.5 hours under vacuum. The peel strengths of the samples made on Cu foils were measured using Instron at 90-degree tilt. The peel strengths of 8.2 N/cm was calculated based on the average load of the highest five peaks. This again demonstrates that high peel strengths suitable for copper clad laminates can be obtained from the compositions made according to this invention.

### Example 36

### Peel Strength Measurement of Glass Cloth Composites

The copolymer of Example 14 (NB/HexenylNB, 75/25 molar ratio) was dissolved in decalin to prepare 15 wt. % solution. To a portion of this solution was added B1000 (20 pphr), T67 (15 pphr), TAIC (10 pphr), DCP (2 pphr), Irganox-1076 (1.75 pphr) and Irgafos-168 (0.6 pphr). Additional amount of decalin (50 pphr) was also added to facilitate the dissolution of all of the components. A thin layer of the composition was applied to a strip (about 2 cm×7 cm) of Cu foil (Mitsui, CF-14X-SV-18) and heated to 130° C. for 1 hour under nitrogen in an oven to remove solvent followed by the cure step at 190° C. for 1.5 hours under vacuum. The peel strength of the sample made on Cu foil was measured using Instron at 90-degree tilt. The peel strengths of 6.1 N/cm was calculated based on the average load of the highest five peaks. This again demonstrates that high peel strengths suitable for copper clad laminates can be obtained from the compositions made according to this invention.

### Example 37

### Film Fusing Studies

A composition prepared according to Example 25A was doctor bladed on a glass substrate and B-staged at 90° C. for 1 hour on a hot plate to remove the solvent. Two rectangular samples of these B-staged films were placed on top of each other in a crosshatch orientation. These samples were pressed using a mechanical press at a pressure of about 5-15 MPa while heating from 30° C. to 120° C. in 30 minutes, keeping the temperature at 120° C. for 35 minutes, heating from 120° C. to 200° C. in 30 minutes and keeping the temperature at 200° C. for 90 minutes. The press was allowed to cool to ambient temperature and the films were taken out and inspected. The two films were completely fused and could not be separated.

### Examples 38A-38E

Cross linking study with varying amounts of CyHexeneNB in polymer composition

A set of NB/HexNB/CyHexeneNB polymers were prepared according to the procedure described in the Example 13. The polymer for the Comparative Example 4 was made using 60/20/20 composition of NB/HexNB/CyHexaneNB where no reactive olefin group (0% CyHexeneNB in the polymer) was present in the composition. The polymer used in Comparative Example 6 is a NB/Ethylene copolymer commercially available as TOPAS® (GPC (THF): M_{w}=84,650, Mₙ=50,150, PDI=1.7). The feed ratios of NB/HexNB/CyHexeneNB varied from 60/37/3 for Comparative Example 5; 60/34/6 for Example 38A; 60/28/12 for Example 38B; 60/25/15 for Example 38C; and 70/10/20 for Example 38D. Each of these polymers were dissolved in decalin to prepare 20 wt. % solutions and all of them contained dicumyl peroxide (DCP) at 4 pphr loading except that the polymer used in Comparative Example 6 and in Example 38D were dissolved in xylenes and also contained DCP at 4 pphr loading.

In addition, to the compositions of Comparative Example 6 (to form composition for Comparative Example 7) and Example 38D (to form composition for Example 38E) were added: T-67 (15 pphr), TAIC (10 pphr), DCP (3 pphr), Irganox-1078 (1.75 pphr) and Irgafos-168 (0.75 pphr).

These compositions were spread on glass substrates and treated to 130° C. for 1 hour under nitrogen inlet and outlet in an oven to remove the solvent. The resulting films were further cured at 190° C. for 2 hours under vacuum in an oven. About 0.14 g-0.35 g of the cured films were mixed with THF (4 g-8 g) and sonicated at about 30° C. for 90 minutes. The insoluble parts of the films were separated from the solutions and dried at 120° C. for 1 hour in an oven in nitrogen atmosphere. The resulting dry weights were used to calculate the percent solubility of cured films in THF. Table 14 lists the amount (mole %) of CyHexeneNB in polymer compositions as measured by ¹³C-NMR and the solubility of cured films in THF. The results suggest that CyHexeneNB composition of more than 4 mole % is sufficient to generate sufficiently cross-linked films. Although the polymer of Comparative Example 6, i.e., NB/ethylene copolymer, exhibits low loss properties, it is not capable of generating compositions for forming thermosets by free-radically initiated cross-linking as envisioned by this invention and as demonstrated by the results presented in Table 14. It should additionally be noted that the cross-linking density of the compositions of this invention can further be increased by incorporating reactive cross-linkers and tackifiers as exemplified in this invention.

Table 14 also summarizes the glass transition temperatures measured for some of the compositions using TMA in compression mode. The cross-linking density of the compositions containing TOPAS can be increased somewhat by addition of reactive tackifiers such as T-67 and cross linkers such as TAIC as indicated by the drop in solubility of the cured films of the Comparative Example 7. However, the films of Comparative Examples 6 and 7 containing TOPAS as the base resin had significantly lower glass transition temperatures than the films of Examples 38D and 38E containing the compositions as described in this invention, thus demonstrating superior properties that are attained by the compositions of this invention.

TABLE 14

| | CyHexeneNB | THF | |
|---|---|---|---|
| Example No | mole % | solubility | T_{g} (° C.) |
| Comparative Example 4 | 0% | 100% | |
| Comparative Example 5 | 3% | 90% | |
| Comparative Example 6 | 0% | 54-79% | 119 |
| Comparative Example 7 | 0% | 12% | 110 |
| Example 38A | 6% | 53% | |
| Example 38B | 12% | 36% | |
| Example 38C | 15% | 30% | |
| Example 38D | 20% | 6% | 190 |
| Example 38E | 20% | 9% | 261 |

### Examples 39A-39D

### Evaluation of Resin Flow in Glass Cloth Composites

The polymers of Examples A, B, C and D were each dissolved in various solvents/solvent mixture to prepare polymer solutions as follows: a 50 wt. % solution in a solvent mixture of cyclohexane/xylene (3:1 weight ratio) using polymers from Examples A and B for Examples 39A and 39B; a 40 wt. % solution in toluene using polymer from Example C for Example 39C; and a 40 wt. % solution in cyclohexane using polymer from Example D for Example 39D. Individually, to portions of these solutions were added B1000 (20 pphr), T67 (15 pphr), TAIC (10 pphr) and Luperox TBEC (3 pphr). Rectangular pieces of about 4 cm×8 cm low Df glass fabric (NE glass cloth, style # 1280, 50 μm) were partially wetted with these compositions to cover about half of the rectangular glass cloth so as to impregnate the glass cloth with this low loss composition. The glass fabric composites were heated to 80° C. for 30 minutes followed by 110° C. for 30 minutes under nitrogen in an oven to remove solvent and generate the prepreg. Each of the prepregs was pressed between two Teflon sheets and two rubber cushions at 4-6 MPa and heated to 175° C. in about 10-15 minutes and cured at 175° C. for 90 minutes to generate glass cloth composites of about 50-60 μm. The visual inspection of the glass cloth showed that the resin in the prepreg has flowed significantly into the untreated areas indicating the suitability of these compositions in Cu-clad laminates where a certain flow of the B-staged resin is required to impregnate the glass cloth and potentially fuse with other layers of the device stack during the cure step. Dk and Df of the cured composites were measured at 10 GHz and are summarized in Table 15.

TABLE 15

| | | | Dk at | Df at |
|---|---|---|---|---|
| Example No. | Polymer | Resin Flow | 10 GHz | 10 GHz |
| Example 39A | Example A | Yes | 2.80 | 0.0017 |
| Example 39B | Example B | Yes | 2.85 | 0.0016 |
| Example 39C | Example C | Yes | 2.68 | 0.0021 |
| Example 39D | Example D | Yes | 2.82 | 0.0014 |

### Examples 40A and 40B

### Resin Flow (Melt Flow) of B-Staged Films

In these two Examples 40A and 40B the compositions from each of Example 40A and 40B (1 mL each) were placed at a center of individual 140 mm×140 mm polyester (PET) film squares, and heated to 110° C. for 1 hour under nitrogen in an oven to remove solvent and generate the B-staged test coin. A second PET film square was placed atop the test coin. The test coin perimeter was traced on the top PET film with a felt tip marker of one color. The test assembly was pressed between two silicon rubber sheets at 3 MPa and heated at 120° C. for about 3 minutes. The test assembly was removed from the press and the new test coin perimeter was traced using a felt tip marker of contrasting color. An image of the test assemblies was taken and loaded into an image processing software. Utilizing the software's freehand selection tool, the initial test coin perimeter was traced and measured for area. This process was repeated for the post pressing test coin perimeter. The resin flow (melt flow) was characterized by the percent change between the initial and post pressing test coin areas.

### Example 40A

High molecular weight NB/HexylNB/CyHexenylNB terpolymer (M_{w}=98,000; molar composition=61/21/18) prepared using the procedure similar to Examples 1-18 and low molecular weight NB/VNB (M_{w}=1,700; molar composition=87/13) prepared using the procedure similar to Examples A-D were combined in wt./wt. ratios of 0/100, 20/80, and 60/40. The polymer blends were dissolved in xylene to prepare 50 wt. % solutions. To these solutions were added B1000 (10 pphr), T-67 (7.5 pphr), TAIC (10 pphr), and DCP (3 pphr). These solutions were then processed using the test procedure described above. FIG. 4 shows the change of the resin flow with increasing weight percentage of the high M_{w} polymer in the B-staged sample. The compositions capable of a range of resin flow during processing of materials such as for Cu-clad laminates can be developed from the compositions when the high M_{w} and low M_{w} polymer compositions are varied as disclosed in this invention.

### Example 40B

The polymers used in this Example 40B were synthesized according to the procedures similar to Examples A-D for low M_{w} polymers and Examples 1-18 for high M_{w} polymers. Low molecular weight NB/CyhexeneNB (M_{w}<3K, 80/20 feed ratio) was dissolved in xylene to prepare a 60 wt. % solution. To this solution was added B-1000 (5 pphr), T-67 (15 pphr), TAIC (10 pphr), SA9000 (5 pphr), DCP (3 pphr), Irgnox-1076 (1.75 pphr), and Irgafos-168 (0.75 pphr). High molecular weight (M_{w}>100K) polymers such as NB/CyhexeneNB (80/20 feed ratio), NB/HexylNB/CyHexeneNB (70/10/20 feed ratio), NB/PENB/CyHexeneNB (70/10/20 feed ratio), NB/VNB (80/20 feed ratio), NB/HexylNB/VNB (70/10/20 feed ratio), and NB/PENB/VNB (70/10/20 feed ratio) were dissolved in xylene to prepare 20 wt. % solutions. To the high M_{w} polymer solutions were added T-67 (15 pphr), TAIC (10 pphr), DCP (3 pphr), Irgnox-1076 (1.75 pphr), and Irgafos-168 (0.75 pphr). The various high molecular weight compositions were blended with the low molecular weight composition so that the high M_{w} to low M_{w} polymer ratio in the mixtures was 60:40. These solutions were then processed using the test procedure described above. Table 16 lists the resin flow obtained when various high M_{w} polymers are blended with low M_{w} (M_{w}<3K) NB/CyclohexeneNB (80/20). The compositions capable of a range of resin flow during processing of materials such as for Cu-clad laminates can be developed from the compositions when the high M_{w} polymer compositions are varied as disclosed in this invention.

TABLE 16

| High Mw Blending Partner | Resin Flow (%) |
|---|---|
| None | >1280 |
| NB/CyhexeneNB | 1170 |
| NB/HexNB/CyHexeneNB | 364 |
| NB/PENB/CyHexeneNB | 518 |
| NB/VNB | 495 |
| NB/HexNB/VNB | 260 |
| NB/PENB/VNB | 317 |

### Comparative Example 1

The terpolymer of Example 3 (NB/BuNB/CyHexeneNB, 40/35/25 molar ratio) was dissolved in mesitylene to prepare 16.6 wt. % solution. To a portion of this solution was added 15 pphr of SA9000 and 4.5 pphr of DCP as the free radical initiator. This composition was doctor-bladed on glass substrate and heated at 130° C. for 1 hour in an oven under nitrogen atmosphere to remove solvent from the film. The solubility of this B-staged film was tested by sonicating small pieces of the film in THF for 1 hour. The B-staged film was further cured at 170° C. for 2 hours in an oven under nitrogen atmosphere to generate cured film having thickness of about 100 μm. The solubility of this cured film was also tested by sonicating small pieces of the film in THF for 1 hour to ensure the film has lost the solubility due to cross linking to generate a thermoset. The dielectric constant (Dk) and dielectric dissipation factor (Df) at 10 GHz were measured for the cured film. Table 1 summarizes the results which is compared with the results obtained for the compositions in Example 19.

### Comparative Examples 2A-2B

### Reliability at 125° C. Storage

The terpolymer of Example 10A (NB/HexNB/CyHexeneNB, 60/20/20 molar ratio) was dissolved in decalin to prepare 20 wt. % solution. To portions of this solution was added T67 (15 pphr), DCP (0.5 pphr), Irganox-1076 (1.50 pphr) and Irgafos-168 (0.38 pphr). Additionally, TAIC (10 pphr) was added to the composition of Comparative Example 2A, but TAIC was not added to composition of Comparative Example 2B. These compositions were doctor-bladed on glass substrates and heated to 130° C. for 1 hour in an oven under nitrogen to remove the solvent. These B-staged films were cured at 190° C. for 1.5 hours under vacuum to obtain films having thickness of about 90 μm (Comparative Example 2A) and 100 μm (Comparative Example 2B). Dielectric constant (Dk) and dielectric dissipation factor Df were measured for Comparative Examples 2A and 2B and the films were placed in an oven at 125° C. under air. The Dk and Df measurements were made at various time intervals up to 1000 hours of storage at 125° C. in air. The results of this reliability measurement is shown in FIG. 1.

### Comparative Example 3

The terpolymer of Example 10A (NB/HexNB/CyHexeneNB, 60/20/20 molar ratio) was dissolved in decalin to prepare 20 wt. % solution. To a portion of this solution was added B1000 (20 pphr), T67 (15 pphr), TAIC (10 pphr), DCP (0.5 pphr), Irganox-1076 (1.75 pphr) and Irgafos-168 (0.75 pphr). Additional amount of decalin (100 pphr) was also added to facilitate the dissolution of all of the components. A thin layer of the composition was applied to a strip (about 2 cm×7 cm) of Cu foil (Mitsui, CF-14X-SV-18) and a low Df glass cloth (NE glass cloth, Style # 1280, 50 μm) was placed on the liquid and thoroughly wetted with the formulation. The glass cloth composite on the Cu foil was heated to 130° C. for 1 hour under nitrogen in an oven to remove solvent followed by the cure step at 190° C. for 1.5 hours under vacuum. The peel strengths of the samples made on Cu foils were measured using Instron at 90-degree tilt. The peel strength was calculated based on the average load of the highest five peaks and listed in Table 13.

Although the invention has been illustrated by certain of the preceding examples, it is not to be construed as being limited thereby; but rather, the invention encompasses the generic area as hereinbefore disclosed. Various modifications and embodiments can be made without departing from the spirit and scope thereof.

What is claimed is:

1. A polymer comprising:
a) at least one first repeating unit represented by formula (IA), said first repeating unit is derived from a monomer of formula (I): 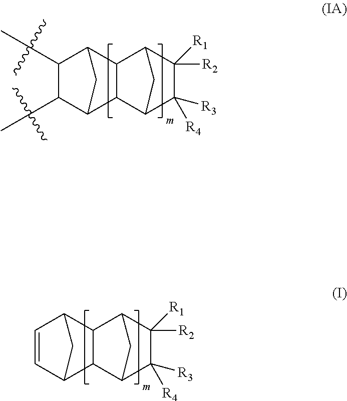
wherein: [symbol]
denotes a place of bonding with another repeat unit;
m is an integer 0, 1 or 2;
R₁, R₂, R₃ and R₄ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
b) at least one second repeating unit represented by formula (IIA), said second repeating unit is derived from a monomer of formula (II): 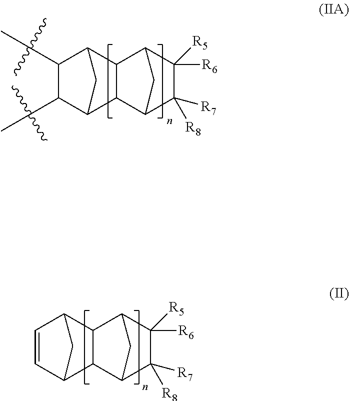
wherein: [symbol]
denotes a place of bonding with another repeat unit;
n is an integer 0, 1 or 2;
at least one of R₅, R₆, R₇ and R₈ is selected from the group consisting of methylidene, ethylidene, vinyl, linear or branched (C₃-C₁₆)alkenyl, (C₃-C₁₀)cycloalkenyl, (C₆-C₁₂)bicycloalkenyl and (C₆-C₁₂)aryl(C₂-C₁₆)alkenyl and the remaining R₅, R₆, R₇ and R₈ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring containing at least one double bond; and
wherein the second repeat unit is present at an amount not less than four mole percent based on total moles of first and second repeat units.

2. The polymer according to claim 1, wherein
m is 0 or 1;
n is 0 or 1;
R₁, R₂, R₃ and R₄ are the same or different and each independently selected from the group consisting of hydrogen, methyl, ethyl, n-propyl, n-butyl, n-hexyl, cyclopentyl, cyclohexyl and norbornyl; or
one of R₁ and R₂ taken together with one of R₃ and R₄ and the carbon atoms to which they are attached to form a cyclopentyl, cyclohexyl, cycloheptyl, bicycloheptyl, bicyclooctyl, or adamantyl ring; and
at least one of R₅, R₆, R₇ and R₈ is selected from the group consisting of ethylidene, vinyl, propenyl, butenyl, pentenyl, hexenyl, heptenyl, octenyl, cyclopentenyl and cyclohexenyl, and the remaining R₅, R₆, R₇ and R₈ are the same or different and each independently selected from the group consisting of hydrogen, methyl, ethyl, n-propyl, n-butyl, n-hexyl, cyclopentyl, cyclohexyl and norbornyl; or
one of R₅ and R₆ taken together with one of R₇ and R₈ and the carbon atoms to which they are attached to form a cyclopentenyl, cyclohexenyl, cycloheptenyl, bicycloheptenyl or bicyclooctenyl ring.

3. The polymer according to claim 1, wherein the monomer of formula (I) is selected from the group consisting of: 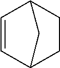
bicyclo[2.2.1]hept-2-ene (norbornene or NB); 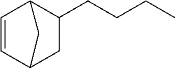
5-butylbicyclo[2.2.1]hept-2-ene (BuNB); 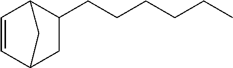
5-hexylbicyclo[2.2.1]hept-2-ene (HexNB); 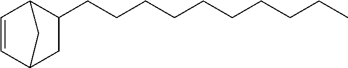 [SMILES: CCCCCCCCCCC1CC2C=CC1C2]
5-decylbicyclo[2.2.1]hept-2-ene (DecNB); 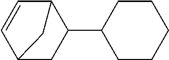 [SMILES: C1=CC2CC1CC2C1CCCCC1]
5-cyclohexylbicyclo[2.2.1]hept-2-ene (CyHexNB); 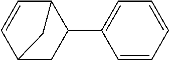 [SMILES: C1=CC2CC1CC2c1ccccc1]
5-phenylbicyclo[2.2.1]hept-2-ene (PhNB); 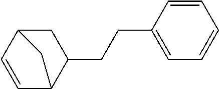 [SMILES: C1=CC2CC1CC2CCc1ccccc1]
5-phenethylbicyclo[2.2.1]hept-2-ene (PENB); 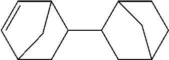 [SMILES: C1=CC2CC1CC2C1CC2CCC1C2]
2,2′-bi(bicyclo[2.2.1]heptan-5-ene) (NBANB); 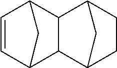 [SMILES: C1=CC2CC1C1C3CCC(C3)C21]
1,2,3,4,4a,5,8,8a-octahydro-1,4:5,8-dimethanonaphthalene (TD); and 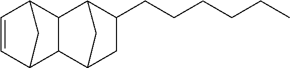 [SMILES: CCCCCCC1CC2CC1C1C3C=CC(C3)C21]
2-hexyl-1,2,3,4,4a,5,8,8a-octahydro-1,4:5,8-dimethanonaphthalene (HexTD).

4. The polymer according to claim 1, wherein the monomer of formula (II) is selected from the group consisting of: 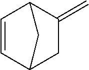
5-methylidenebicyclo[2.2.1]hept-2-ene (MNB); 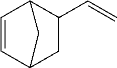
5-vinylbicyclo[2.2.1]hept-2-ene (VNB); 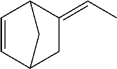
5-ethylidenebicyclo[2.2.1]hept-2-ene (ENB); 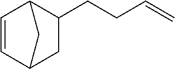
5-(but-3-en-1-yl)bicyclo[2.2.1]hept-2-ene (ButenylNB); 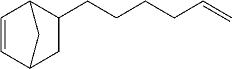
5-(hex-5-en-1-yl)bicyclo[2.2.1]hept-2-ene (HexenylNB); 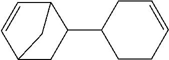 [SMILES: C1=CCC(C2CC3C=CC2C3)CC1]
5-(cyclohex-3-en-1-yl)bicyclo[2.2.1]hept-2-ene (CyclohexeneNB); 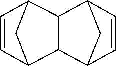 [SMILES: C1=CC2CC1C1C3C=CC(C3)C21]
1,4,4a,5,8,8a-hexahydro-1,4:5,8-dimethanonaphthalene (TDD); 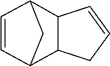
3a,4,7,7a-tetrahydro-1H-4,7-methanoindene (DCPD); and 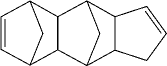 [SMILES: C1=CC2C(C1)C1CC2C2C3C=CC(C3)C12]
3a,4,4a,5,8,8a,9,9a-octahydro-1H-4,9:5,8-dimethanocyclopenta[b]naphthalene (CPD3).

5. The polymer according to claim 1, which is selected from the group consisting of:
a copolymer of norbornene (NB) and 5-vinylbicyclo[2.2.1]hept-2-ene (VNB);
a copolymer of norbornene (NB) and 5-ethylidenebicyclo[2.2.1]hept-2-ene (ENB);
a copolymer of norbornene (NB) and 5-(but-3-en-1-yl)bicyclo[2.2.1]hept-2-ene (ButenylNB);
a copolymer of norbornene (NB) and 5-hex-5-en-1-yl)bicyclo[2.2.1]hept-2-ene (HexenylNB); and
a copolymer of norbornene (NB) and 5-cyclohex-3-en-1-yl)bicyclo[2.2.1]hept-2-ene (CyclohexeneNB);
a terpolymer of norbornene (NB), 5-butylbicyclo[2.2.1]hept-2-ene (BuNB) and 5-(but-3-en-1-yl)bicyclo[2.2.1]hept-2-ene (ButenylNB);
a terpolymer of norbornene (NB), 5-butylbicyclo[2.2.1]hept-2-ene (BuNB) and 5-(cyclohex-3-en-1-yl)bicyclo[2.2.1]hept-2-ene (CyclohexeneNB);
a terpolymer of norbornene (NB), 5-hexylbicyclo[2.2.1]hept-2-ene (HexNB) and 5-(but-3-en-1-yl)bicyclo[2.2.1]hept-2-ene (ButenylNB);
a terpolymer of norbornene (NB), 5-hexylbicyclo[2.2.1]hept-2-ene (HexNB) and 5-(hex-5-en-1-yl)bicyclo[2.2.1]hept-2-ene (HexenylNB); and
a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB).

6. The polymer according to claim 1, wherein the second repeat unit is present at an amount in the range from about five mole percent to about thirty mole percent based on total moles of first and second repeat units.

7. The polymer according to claim 1, wherein the first repeat unit is derived from two distinct monomers of formula (I).

8. A composition comprising:
a) a polymer comprising:
i) at least one first repeating unit represented by formula (IA), said first repeating unit is derived from a monomer of formula (I): 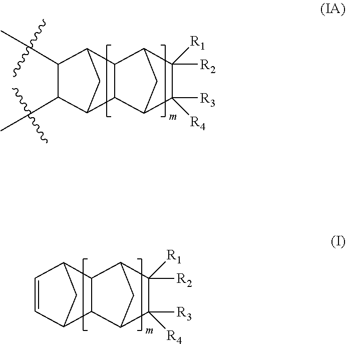
wherein: [symbol]
denotes a place of bonding with another repeat unit;
m is an integer 0, 1 or 2;
R₁, R₂, R₃ and R₄ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
ii) at least one second repeating unit represented by formula (IIA), said second repeating unit is derived from a monomer of formula (II): 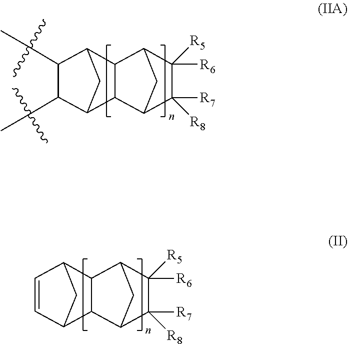
wherein: [symbol]
denotes a place of bonding with another repeat unit;
n is an integer 0, 1 or 2;
at least one of R₅, R₆, R₇ and R₈ is selected from the group consisting of methylidene, ethylidene, vinyl, linear or branched (C₃-C₁₆)alkenyl, (C₃-C₁₀)cycloalkenyl, (C₆-C₁₂)bicycloalkenyl and (C₆-C₁₂)aryl(C₂-C₁₆)alkenyl and the remaining R₅, R₆, R₇ and R₈ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring containing at least one double bond;
and
wherein the second repeat unit is present at an amount not less than four mole percent based on total moles of first and second repeat units;
b) a crosslinking agent selected from the group consisting of: 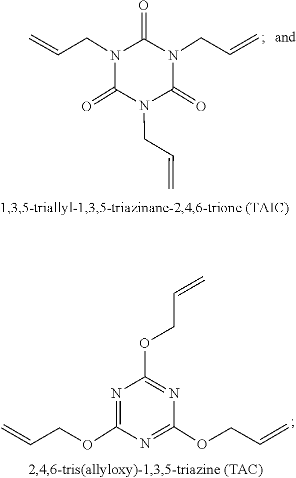
and
c) one or more additives selected from the group consisting of a tackifier and a free radical initiator.

9. The composition according to claim 8, wherein the first repeat unit of the polymer is derived from the monomer of formula (I) selected from the group consisting of: 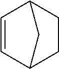
bicyclo[2.2.1]hept-2-ene (norbornene or NB); 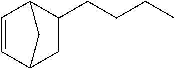
5-butylbicyclo[2.2.1]hept-2-ene (BuNB); 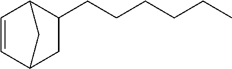
5-hexylbicyclo[2.2.1]hept-2-ene (HexNB); 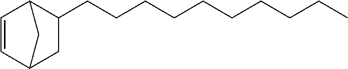 [SMILES: CCCCCCCCCCC1CC2C=CC1C2]
5-decylbicyclo[2.2.1]hept-2-ene (DecNB); 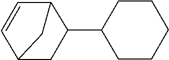 [SMILES: C1=CC2CC1CC2C1CCCCC1]
5-cyclohexylbicyclo[2.2.1]hept-2-ene (CyHexNB); 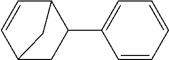 [SMILES: C1=CC2CC1CC2c1ccccc1]
5-phenylbicyclo[2.2.1]hept-2-ene (PhNB); 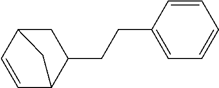 [SMILES: C1=CC2CC1CC2CCc1ccccc1]
5-phenethylbicyclo[2.2.1]hept-2-ene (PENB); 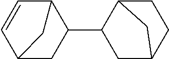 [SMILES: C1=CC2CC1CC2C1CC2CCC1C2]
2,2′-bi(bicyclo[2.2.1]heptan-5-ene) (NBANB); 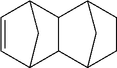 [SMILES: C1=CC2CC1C1C3CCC(C3)C21]
1,2,3,4,4a,5,8,8a-octahydro-1,4:5,8-dimethanonaphthalene (TD); and 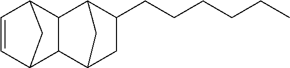 [SMILES: CCCCCCC1CC2CC1C1C3C=CC(C3)C21]
2-hexyl-1,2,3,4,4a,5,8,8a-octahydro-1,4:5,8-dimethanonaphthalene (HexTD).

10. The composition according to claim 8, wherein the second repeat unit of the polymer is derived from the the monomer of formula (II) selected from the group consisting of: 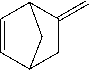
5-methvlidenebicyclo[2.2.1]hept-2-ene (MNB); 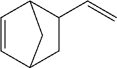
5-vinylbicyclo[2.2.1]hept-2-ene (VNB); 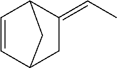
5-ethylidenebicyclo[2.2.1]hept-2-ene (ENB); 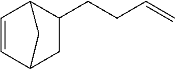
5-(but-3-en-1-yl)bicyclo[2.2.1]hept-2-ene (ButenylNB); 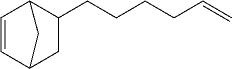
5-(hex-5-en-1-yl)bicyclo[2.2.1]hept-2-ene (HexenylNB); 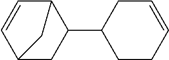 [SMILES: C1=CCC(C2CC3C=CC2C3)CC1]
5-(cyclohex-3-en-1-yl)bicyclo[2.2.1]hept-2-ene (CyHexeneNB); 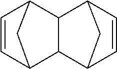 [SMILES: C1=CC2CC1C1C3C=CC(C3)C21]
1,4,4a,5,8,8a-hexahydro-1,4:5,8-dimethanonaphthalene (TDD); 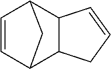
3a,4,7,7a-tetrahydro-1H-4,7-methanoindene (DCPD); and 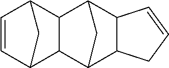 [SMILES: C1=CC2C(C1)C1CC2C2C3C=CC(C3)C12]
3a,4,4a,5,8,8a,9,9a-octahydro-1H-4,9:5,8-dimethanocyclopenta[b]naphthalene (CPD3).

11. The composition according to claim 8, wherein the second repeat unit of the polymer is present at an amount in the range from about five mole percent to about thirty mole percent based on the total moles of first and second repeat units.

12. The composition according to claim 8, wherein the polymer is selected from the group consisting of:
a copolymer of norbornene (NB) and 5-vinylbicyclo[2.2.1]hept-2-ene (VNB);
a copolymer of norbornene (NB) and 5-ethylidenebicyclo[2.2.1]hept-2-ene (ENB);
a copolymer of norbornene (NB) and 5-(but-3-en-1-yebicyclo[2.2.1]hept-2-ene (ButenylNB);
a copolymer of norbornene (NB) and 5-hex-5-en-1-yl)bicyclo[2.2.1]hept-2-ene (HexenylNB); and
a copolymer of norbornene (NB) and 5-cyclohex-3-en-1-yl)bicyclo[2.2.1]hept-2-ene (CyclohexeneNB);
a terpolymer of norbornene (NB), 5-butylbicyclo[2.2.1]hept-2-ene (BuNB) and 5-(but-3-en-1-yl)bicyclo[2.2.1]hept-2-ene (ButenylNB);
a terpolymer of norbornene (NB), 5-butylbicyclo[2.2.1]hept-2-ene (BuNB) and 5-(cyclohex-3-en-1-yl)bicyclo[2.2.1]hept-2-ene (CyclohexeneNB);
a terpolymer of norbornene (NB), 5-hexylbicyclo[2.2.1]hept-2-ene (HexNB) and 5-(but-3-en-1-yl)bicyclo[2.2.1]hept-2-ene (ButenylNB);
a terpolymer of norbornene (NB), 5-hexylbicyclo[2.2.1]hept-2-ene (HexNB) and 5-(hex-5-en-1-yl)bicyclo[2.2.1]hept-2-ene (HexenylNB); and
a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB).

13. The composition according to claim 8, wherein the tackifier is selected from the group consisting of: 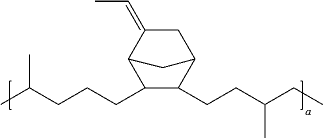
ethylene-propylene-ethylidenenorbornene terpolymer, where a is at least 100; 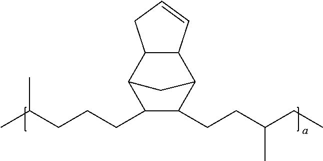
ethylene-propylene-dicyclopentadiene terpolymer, where a is at least 100; 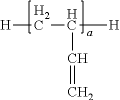
1,2-butadiene rubber, where a is at least 100; 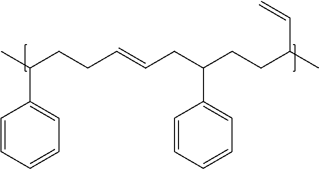
styrene/butadiene rubber 1; 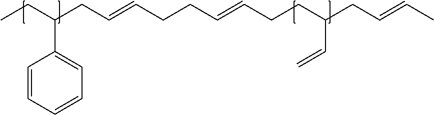
styrene/butadiene rubber 2; 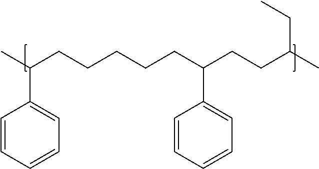
hydrogenated styrene/butadiene rubber 1; and 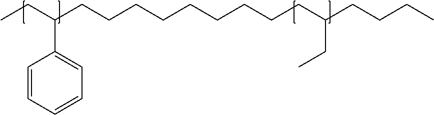
hydrogenated styrene/butadiene rubber 2.

14. The composition according to claim 8, wherein the free radical generator is selected from the group consisting of: 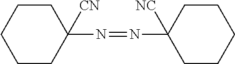 [SMILES: N#CC1(N=NC2(C#N)CCCCC2)CCCCC1]
1,1′-(diazene-1,2-diyl)bis(cyclohexane-1-carbonitrile); 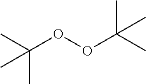
di-tert-butyl peroxide; 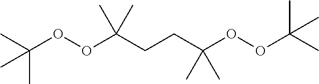 [SMILES: CC(C)(C)OOC(C)(C)CCC(C)(C)OOC(C)(C)C]
2,5-bis(tert-butylperoxy)-2,5-dimethylhexane; 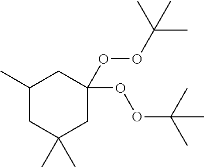 [SMILES: CC1CC(C)(C)CC(OOC(C)(C)C)(OOC(C)(C)C)C1]
1,1-bis(tert-butylueroxy)-3,3,5-trimethylcyclohexane; 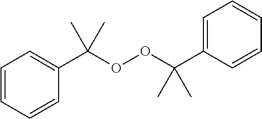 [SMILES: CC(C)(OOC(C)(C)c1ccccc1)c1ccccc1]
dicumyl peroxide; 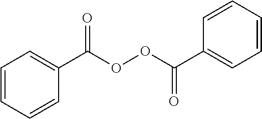 [SMILES: O=C(OOC(=O)c1ccccc1)c1ccccc1]
benzoyl peroxide; 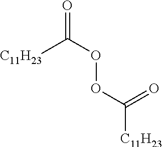
dodecanoic peroxyanhydride; 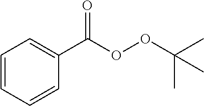
tert-butyl benzoperoxoate; and 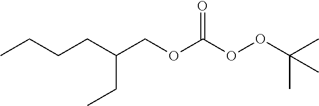 [SMILES: CCCCC(CC)COC(=O)OOC(C)(C)C]
tert-butyl (2-ethylhexyl) carbonoperoxoate.

15. The composition according to claim 8, which is selected from the group consisting of:
a solution containing a mixture of a terpolymer of norbornene (NB), 5-butylbicyclo[2.2.1]hept-2-ene (BuNB) and 5-(but-3-en-1-yebicyclo[2.2.1]hept-2-ene (ButenylNB); 1,3,5-triallyl-1,3,5-triazinane-2,4,6-trione (TAIC) and dicumyl peroxide (DCP);
a solution containing a mixture of a terpolymer of norbornene (NB), 5-butylbicyclo[2.2.1]hept-2-ene (BuNB) and 5-(but-3-en-1-yebicyclo[2.2.1]hept-2-ene (ButenylNB); 1,3,5-triallyl-1,3,5-triazinane-2,4,6-trione (TAIC), 1,2-butadiene rubber and dicumyl peroxide (DCP);
a solution containing a mixture of a terpolymer of norbornene (NB), 5-butylbicyclo[2.2.1]hept-2-ene (BuNB) and 5-(but-3-en-1-yebicyclo[2.2.1]hept-2-ene (ButenylNB); 1,3,5-triallyl-1,3,5-triazinane-2,4,6-trione (TAIC), 1,2-butadiene rubber, poly-aryl ether cross linker end capped with methacrylate groups and dicumyl peroxide (DCP);
a solution containing a mixture of a terpolymer of norbornene (NB), 5-butylbicyclo[2.2.1]hept-2-ene (BuNB) and 5-(cyclohex-3-en-1-yl)bicyclo[2.2.1]hept-2-ene (CyclohexeneNB); 1,3,5-triallyl-1,3,5-triazinane-2,4,6-trione (TAIC), 1,2-butadiene rubber and dicumyl peroxide (DCP);
a solution containing a mixture of a copolymer of norbornene (NB) and 5-(but-3-en-1-yl)bicyclo[2.2.1]hept-2-ene (ButenylNB); 1,2-butadiene rubber and dicumyl peroxide (DCP);
a solution containing a mixture of a copolymer of norbornene (NB) and 5-(but-3-en-1-yl)bicyclo[2.2.1]hept-2-ene (ButenylNB); ethylene-propylene-dicyclopentadiene terpolymer and dicumyl peroxide (DCP);
a solution containing a mixture of a copolymer of norbornene (NB) and 5-(but-3-en-1-yl)bicyclo[2.2.1]hept-2-ene (ButenylNB); ethylene-propylene-ethylidenenorbornene terpolymer and dicumyl peroxide (DCP);
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 1,3,5-triallyl-1,3,5-triazinane-2,4,6-trione (TAIC), 1,2-butadiene rubber and dicumyl peroxide (DCP);
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 1,2-butadiene rubber and dicumyl peroxide (DCP);
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 1,2-butadiene rubber, ethylene-propylene-ethylidenenorbornene terpolymer and dicumyl peroxide (DCP);
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 1,3,5-triallyl-1,3,5-triazinane-2,4,6-trione (TAIC), 1,2-butadiene rubber, ethylene-propylene-ethylidenenorbornene terpolymer and dicumyl peroxide (DCP); and
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 2,4,6-tris(allyloxy)-1,3,5-triazine (TAC), 1,2-butadiene rubber and dicumyl peroxide (DCP).

16. A film formed from the composition according to claim 8.

17. The film according to claim 16, which has a dielectric constant (Dk) less than 3 at a frequency of 10 GHz, a glass transition temperature higher than 150° C. and a coefficient of thermal expansion (CTE) less than 130 ppm/K.

18. The film according to claim 16, which is formed from a composition selected from the group consisting of:
a solution containing a mixture of a terpolymer of norbornene (NB), 5-butylbicyclo[2.2.1]hept-2-ene (BuNB) and 5-(but-3-en-1-yl)bicyclo[2.2.1]hept-2-ene (ButenylNB); 1,3,5-triallyl-1,3,5-triazinane-2,4,6-trione (TAIC) and dicumyl peroxide (DCP);
a solution containing a mixture of a terpolymer of norbornene (NB), 5-butylbicyclo[2.2.1]hept-2-ene (BuNB) and 5-(but-3-en-1-yl)bicyclo[2.2.1]hept-2-ene (ButenylNB); 1,3,5-triallyl-1,3,5-triazinane-2,4,6-trione (TAIC), 1,2-butadiene rubber and dicumyl peroxide (DCP);
a solution containing a mixture of a terpolymer of norbornene (NB), 5-butylbicyclo[2.2.1]hept-2-ene (BuNB) and 5-(but-3-en-1-yl)bicyclo[2.2.1]hept-2-ene (ButenylNB); 1,3,5-triallyl-1,3,5-triazinane-2,4,6-trione (TAIC), 1,2-butadiene rubber, poly-aryl ether cross linker end capped with methacrylate groups and dicumyl peroxide (DCP);
a solution containing a mixture of a terpolymer of norbornene (NB), 5-butylbicyclo[2.2.1]hept-2-ene (BuNB) and 5-(cyclohex-3-en-1-yl)bicyclo[2.2.1]hept-2-ene (CyclohexeneNB); 1,3,5-triallyl-1,3,5-triazinane-2,4,6-trione (TAIC), 1,2-butadiene rubber and dicumyl peroxide (DCP);
a solution containing a mixture of a copolymer of norbornene (NB) and 5-(but-3-en-1-yl)bicyclo[2.2.1]hept-2-ene (ButenylNB); 1,2-butadiene rubber and dicumyl peroxide (DCP);
a solution containing a mixture of a copolymer of norbornene (NB) and 5-(but-3-en-1-yl)bicyclo[2.2.1]hept-2-ene (ButenylNB); ethylene-propylene-dicyclopentadiene terpolymer and dicumyl peroxide (DCP);
a solution containing a mixture of a copolymer of norbornene (NB) and 5-(but-3-en-1-yl)bicyclo[2.2.1]hept-2-ene (ButenylNB); ethylene-propylene-ethylidenenorbornene terpolymer and dicumyl peroxide (DCP);
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 1,3,5-triallyl-1,3,5-triazinane-2,4,6-trione (TAIC), 1,2-butadiene rubber and dicumyl peroxide (DCP);
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 1,2-butadiene rubber and dicumyl peroxide (DCP);
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 1,2-butadiene rubber, ethylene-propylene-ethylidenenorbornene terpolymer and dicumyl peroxide (DCP);
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 1,3,5-triallyl-1,3,5-triazinane-2,4,6-trione (TAIC), 1,2-butadiene rubber, ethylene-propylene-ethylidenenorbornene terpolymer and dicumyl peroxide (DCP); and
a solution containing a mixture of a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB); 2,4,6-tris(allyloxy)-1,3,5-triazine (TAC), 1,2-butadiene rubber and dicumyl peroxide (DCP).

19. A glass composite film formed from the polymer of claim 1.

20. The film according to claim 19, which has a dielectric constant (Dk) less than 2.6 at a frequency of 10 GHz, a peel strength higher than 5.5 N/cm and a coefficient of thermal expansion (CTE) less than 40 ppm/K.
